(19) United States
(12) Patent Application Publication
(10) Pub. No.: US 2011/0297070 A1
(43) Pub. Date: Dec. 8, 2011

(54) Propulsion System for an Autonomous Underwater Vehicle

(76) Inventors: Neil P. Riggs, St. John's (CA); Ralf Bachmayer, St. John's (CA); Christopher D. Williams, St. John's (CA)

(21) Appl. No.: 13/099,909

(22) Filed: May 3, 2011

Related U.S. Application Data
(63) Continuation of application No. PCT/CA2009/001588, filed on Nov. 4, 2009.
(60) Provisional application No. 61/111,201, filed on Nov. 4, 2008.

(51) Int. Cl. B63G 8/14; G05D 1/00; B63G 8/08

(52) U.S. Cl. 114/330; 701/21

(57) ABSTRACT

An underwater vehicle is provided to move in various orientations and directions, including pitch, yaw, roll, heave, surge and sway. The underwater vehicle comprises an upper body and a lower body, wherein both bodies are separated by two rudders. One rudder is positioned towards the fore of the underwater vehicle, while the other is positioned towards the aft. Each rudder forms the basis of a propulsion system, such that the underwater vehicle has at least two independently controlled propulsion systems. Each propulsion system further comprises an elevator extending horizontally from the sides of each rudder and a thrust generator attached to the elevator. The elevator and thrust generator are able to pitch about an axis extending horizontally through the sides of the rudder, and the rudder is able to yaw about an axis extending vertically through the top and bottom of said rudder.

### CROSS-REFERENCE TO RELATED APPLICATIONS

The present application is a continuation of PCT Application No. PCT/CA2009/001588 filed on Nov. 4, 2009 which claims priority from U.S. Provisional Application No. 61/111,201 filed on Nov. 4, 2008 incorporated herein by reference.

### TECHNICAL FIELD

The following relates generally to propulsions systems for marine vehicles, and has particular utility when applied to underwater vehicles.

### DESCRIPTION OF THE RELATED ART

In the field of marine vehicles, a vehicle may be propelled using one or more fixed rear thrusters and the vehicle's orientation and positioning may be controlled using various control surfaces mounted to the hull of the vehicle. The flow of water across the control surfaces generates a force depending on the orientation of the control surface, and thus a force on the vehicle itself. Such an arrangement may be suitable when the vehicle is moving at sufficiently high speeds, wherein a greater force is generated as more water flows over the control surfaces.

At slower speeds, generally less water flows over the control surfaces, thereby reducing the force directed to control the vehicle. The reduced force generated by the control surfaces affects the performance of underwater vehicles when carrying out hovering manoeuvres. During a hovering manoeuvre, an underwater vehicle may maintain a generally fixed position and orientation of the vehicle's hull for some time period, while compensating for the effects of cross-currents. This manoeuvrability may be used in various underwater operations, including without limitation, inspections that may involve high-detail imaging equipment and robotic manipulations that may involve precise movements.

Differential thrust systems may be used to produce a hover in low-speed underwater conditions. Generally, a differential thrust system may comprise several thrusters that are mounted at strategic locations around a vehicle and these thrusters are aimed in certain directions, allowing the vehicle to have some percentage of its total available thrust act in any direction. By varying the magnitude of thrust from each of the thrusters, a vehicle may be able to manoeuvre in various dimensions. Many remotely operated underwater vehicles (ROVs) may make use of differential thrust systems.

The differential thrust system for propulsion allows for hovering for inspection and intervention in low speed applications and environments. The differential thrusters also suitably compensate for cross-current conditions while maintaining an absolute heading.

There are many configurations that strive to optimize the positioning of differential thrusters for increased control, such as positioning each of the differential thrusters away from vehicle's hull. However, many of such configurations may also reduce the hydrodynamic streamlining of the underwater vehicle, thereby leading to a loss in energy efficiency.

In many cases, the reduced operational and travel efficiency is compensated by tethering the underwater vehicle, wherein the tether provides some form of energy to the vehicle. As a result, an underwater vehicle's travel distance and path is limited to the length of the tether. Moreover, the above design considerations can add additional cost and complexity to an underwater vehicle.

It is an object of the following to provide a propulsion system that is configured to address the above issues.

### SUMMARY OF THE INVENTION

In one aspect, there is provided an underwater propulsion system comprising at least one assembly comprising a rudder configured to be rotatably connected to the hull of an underwater vehicle to permit complete rotation of the rudder with respect to the hull, an elevator pivotally attached to the rudder to pitch about an axis perpendicular to the axis of rotation of the rudder, and a thrust generator extending from and attached to the elevator such that the thrust generator pitches with the elevator.

In another aspect, there is provided an underwater vehicle comprising: a first body and a second body positioned in spaced relation to one another and separated by at least one propulsion assembly; and the at least one propulsion assembly, each propulsion assembly comprising: a vertically oriented rudder configured to be rotatably connected between the upper and lower bodies and is fully rotatable about an axis of rotation; an elevator pivotally attached to the rudder to pitch about an axis perpendicular to the axis of rotation of the rudder; and a thrust generator extending from and attached to the elevator such that the thrust generator pitches with the elevator.

### BRIEF DESCRIPTION OF THE DRAWINGS

Embodiments will now be described by way of example only with reference to the appended drawings wherein:

FIG. 1a is a perspective view of an exemplary underwater vehicle.

FIG. 1b is a top planar view of the underwater vehicle shown in FIG. 1a.

FIG. 2 is a perspective view in isolation of the exemplary propulsion system shown in FIG. 1a.

FIG. 3 is a block diagram of an exemplary embodiment of an underwater vehicle and propulsion system.

FIG. 4 is a perspective view of the propulsion system similar to FIG. 2 and showing various internal components shown schematically in FIG. 3.

FIG. 5a is a top planar view of top and bottom cross sections of the rudder, shown in FIG. 2.

FIG. 5b is a top planar view of a middle cross section of the rudder, shown in FIG. 2.

FIG. 6 is a top planar view in isolation of the propulsion system shown in FIG. 2.

FIG. 7 is a profile view of a partial cross section of another embodiment of a propulsion system shown in isolation.

FIG. 8 is a profile view of a partial cross section of yet another embodiment of a propulsion system shown in isolation.

FIG. 9 is a perspective view of another embodiment of an exemplary underwater vehicle deployed in an underwater environment.

FIG. 10 is a perspective view of the underwater vehicle shown in FIG. 9 while heaving, surging and pitching.

FIG. 11a is a perspective view of the rotational axes of the underwater vehicle shown in FIG. 10, relative to the underwater vehicle's reference frame axes.

FIG. 11b is a profile view of the rotational axes of the underwater vehicle shown in FIG. 10, relative to the underwater vehicle's reference frame axes.

FIG. 11c is a planar view of the rotational axes of the underwater vehicle shown in FIG. 10, relative to the underwater vehicle's reference frame axes.

FIG. 12 is a perspective view of the underwater vehicle shown in FIG. 9 while heaving.

FIG. 13a is a perspective view of the rotational axes of the underwater vehicle shown in FIG. 12, relative to the underwater vehicle's reference frame axes.

FIG. 13b is a profile view of the rotational axes of the underwater vehicle shown in FIG. 12, relative to the underwater vehicle's reference frame axes.

FIG. 13c is a planar view of the rotational axes of the underwater vehicle shown in FIG. 12, relative to the underwater vehicle's reference frame axes.

FIG. 14 is a perspective view of the underwater vehicle shown in FIG. 9 while yawing.

FIG. 15a is a perspective view of the rotational axes of the underwater vehicle 3 shown in FIG. 14, relative to the underwater vehicle's reference frame axes.

FIG. 15b is a profile view of the rotational axes of the underwater vehicle shown in FIG. 14, relative to the underwater vehicle's reference frame axes.

FIG. 15c is a planar view of the rotational axes of the underwater vehicle shown in FIG. 14, relative to the underwater vehicle's reference frame axes.

FIG. 16 is a perspective view of an underwater vehicle shown in a hovering manoeuvre.

FIG. 17 is a perspective view of an underwater vehicle shown in a zero-turn radius manoeuvre.

FIG. 18 is a perspective view of an underwater vehicle shown in a “crabbing” manoeuvre.

FIG. 19 is a profile view of another embodiment of an underwater vehicle shown with clam shell fairings and nose cone fairings.

FIG. 20 is a profile view of the underwater vehicle shown in FIG. 19 shown with the clam shell fairings removed.

FIG. 21 is a profile view of the underwater vehicle shown in FIG. 19 shown with the clam shell fairings and the nose cone fairings removed.

FIG. 22 is a perspective view of a frame of an underwater vehicle.

FIG. 23 is a perspective view of another embodiment of a frame of an underwater vehicle.

FIG. 24 is profile view of a partial cross section of the underwater vehicle shown in FIG. 19 showing various components therein.

FIG. 25 is a schematic block diagram of an example propulsion control system.

FIG. 26 is a block diagram illustrating various modules implemented by a software architecture used by the propulsion control system.

FIG. 27 is a process diagram illustrating various processes implemented by the software architecture in FIG. 26.

FIG. 28 is a process diagram illustrating further detail for the mission processor shown in FIG. 26.

FIG. 29 is a control logic diagram illustrating use of pitch feedback.

FIG. 30 is a control logic diagram illustrating use of depth feedback.

FIG. 31 is a control logic diagram illustrating use of heading feedback.

FIG. 32 is a control logic diagram illustrating use of velocity feedback.

FIG. 33 is a control logic diagram illustrating use of distance feedback.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Generally, underwater vehicles comprise a body or hull to transport various loads while protecting the loads from a submersed marine environment. Various loads may include without limitation, scientific equipment, people and components required to operate the underwater vehicle. The body or hull of a vehicle may protect the loads from the effects of the water, including wetting, and hydrostatic and hydrodynamic pressure. Typically a propulsion unit attached to the body is used to move the body in certain directions.

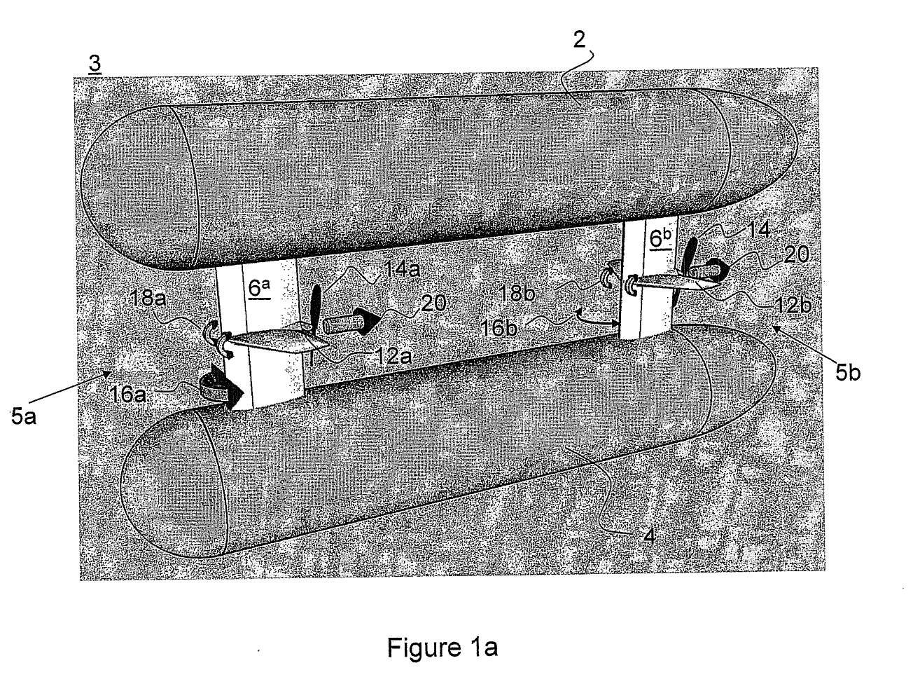

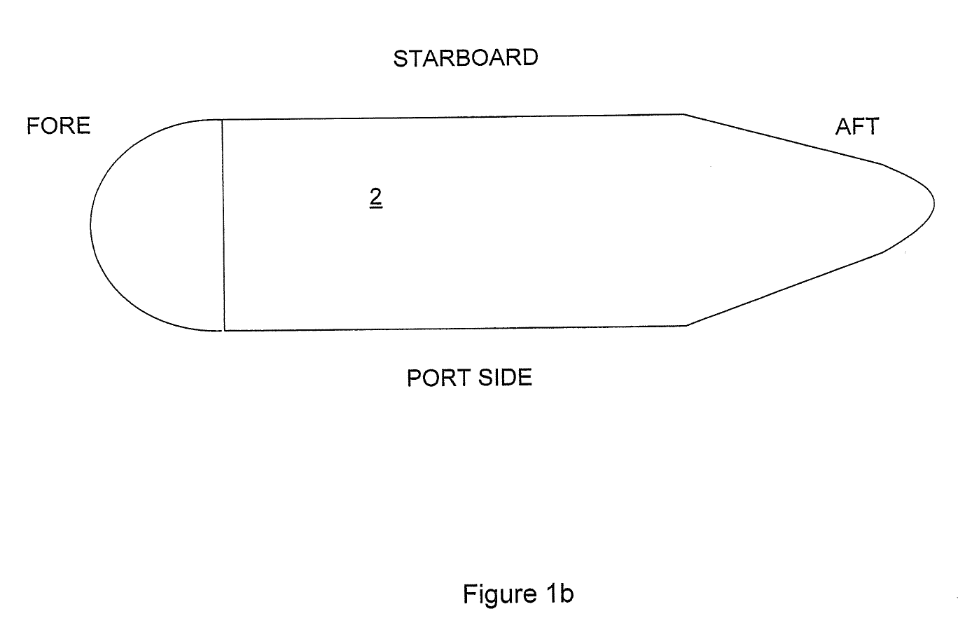

FIG. 1a shows an underwater vehicle 3 comprising two bodies or hulls, an upper body 2 and a lower body 4. It is noted that the terms ‘body’ and ‘hull’ refer to the same structure, as described in more detail below. Both bodies 2, 4 comprise an oblong-shaped geometry for streamlining. In the particular embodiment shown in the FIG. 1a, both the upper and lower bodies 2, 4 comprise a cylindrical hull having the end portions rounded to reduce hydrodynamic resistance. It is noted that the front end, or nose, of each body 2, 4 may comprise a more hemispherical geometry, while the rear end, or tail, may comprise a more conical geometry. This profiled geometry allows for reduced water drag. The purpose of each body or hull 2, 4 is to house various loads while streamlining the flow of water over the surface of each body or hull 2, 4 and that any means of doing so are encompassed within the various possible configurations for the underwater vehicle 3.

Turning to FIG. 1b, a top planar view of the underwater vehicle 3 is shown in context with directional terminology. The front of the underwater vehicle 3 is referred to as the fore and the rear is referred to as the aft. From the perspective of a person on the underwater vehicle 3 facing towards the fore, the left-hand side is referred to as the portside, while the right-hand side is referred to as the starboard.

Returning to FIG. 1a, the underwater vehicle 3 is propelled by at least two propulsion systems, denoted 5a for the fore propulsion system and 5b for the aft propulsion system. For continued clarity of the description, suffix ‘a’ herein refers to the fore portion of the underwater vehicle 3 and suffix ‘b’ refers to the aft portion. The upper body 2 is positioned directly above the lower body 4 and extending vertically between the two bodies 2,4 are a pair of rudders 6a, 6b. In the embodiment shown in FIG. 1a, a fore rudder 6a is positioned towards the front of the underwater vehicle 3 and an aft rudder 6b is positioned towards the back of the underwater vehicle 3. Both the fore rudder 6a and aft rudder 6b comprise rigid structures that position the upper body 2 at a fixed distance from the lower body 4. It is appreciated that a rudder 6 is a control surface that affects the yaw of the underwater vehicle 3. Both rudders 6a, 6b are able to yaw independently of each other, as indicated by the movement arrows 16a and 16b. The fore and aft positioning of the rudders 6a, 6b and the independent direction of yaw forces generated from the fore rudder 6a and aft rudder 6b allow for manoeuvres of various complexities as discussed further below.

In this example, the purpose of each rudder 6 is to act as a control surface affecting the yaw, and any configuration capable of doing so is encompassed by the embodiments described herein.

The two rudders 6a, 6b form a structural base for the underwater vehicle's propulsion system 5a, 5b, respectively, which further comprises respective elevators 12 and thrusters 14. An elevator 12 protrudes from both sides of a rudder 6 and comprises a rigid control surface or plane that is generally perpendicular to the rudder 6. The flow of fluid over the elevator 12 generates forces that affect the pitch or inclination of the underwater vehicle 3. Each elevator 12 is able to rotate or pitch, as indicated by the movement arrows 18a and 18b. In the embodiment shown in FIG. 1a, both the fore elevator 12a and aft elevator 12b have a swept wing geometry to reduce drag. It is understood that elevators 12 comprising other geometries to control the pitch while reducing drag are equally applicable.

Similar to the rudders 6a, 6b, both the fore elevator 12a and aft elevator 12b are able to move independently from one another. In one example, the fore elevator 12a may pitch downwards, while the aft elevator 12b may pitch upwards to create a coupled moment, thereby pitching the underwater vehicle 3 downwards. The fore and aft positioning of the elevators 12a, 12b and the independent direction of pitch forces generated from the fore elevator 12a and aft elevator 12b allow for manoeuvres of various complexities as discussed further below.

In another embodiment, each of the elevators 12 can be defined by a starboard elevator component and a portside elevator component. The starboard elevator component of an elevator 12 may be able to pitch independently from the portside elevator component, thereby providing further manoeuvrability. It is understood that each of the starboard elevator component and the portside elevator component would be actuated by separate motors for independent control and movement.

It is noted that all control planes (i.e. rudder 6 and elevator 12) advantageously use NACA 00xx airfoil profiles, an industry standard in naval architecture. The NACA 00xx airfoil profiles provide hydrodynamic efficiency and geometrical convenience. It will be appreciated that other airfoil profiles that allow for the same are equally applicable.

Fixed to each elevator 12 is a thrust generator 14, such that the thrust generator 14 is oriented with the same pitch as the elevator moves. Since each elevator 12 is fixed to a rudder 6, the elevator 12 and, therefore the thrust generator 14, will also be oriented to have the same yaw as the rudder 6. The thrust generator 14 is located behind the trailing edge of the rudder 6 so as to allow for a larger range of pitch rotation, while avoiding interference between the thrust generator 14 and rudder 6. Other configurations between the thrust generator 14, elevator 12, and rudder 6 that allow the thrust generator to move across a sufficient range for pitch and yaw are equally applicable.

The thrust generator 14 shown in FIG. 1a, comprises a single propeller driven by a motor. Other embodiments of a thrust generator 14 may include one more motors driving one or more propellers. Alternatively, a thrust generator 14 may comprise the release of a pressurized gas or liquid. It is appreciated that any mechanisms for generating thrust are equally applicable.

The direction of the force generated by the thrust generator 14 is indicated by the direction arrows 20a and 20b. The coupling of a thrust generator 14 to the elevator 12 and rudder 6, allows the thrust generator 14 to direct the thrust at various pitch and yaw angles. The independent movement of the fore and aft thrust generators 14a, 14b, and the positioning of the thrust generators 14a, 14b in relation to the upper and lower bodies 2, 4 allow the underwater vehicle 3 to carry out complex manoeuvres, discussed in further detail below.

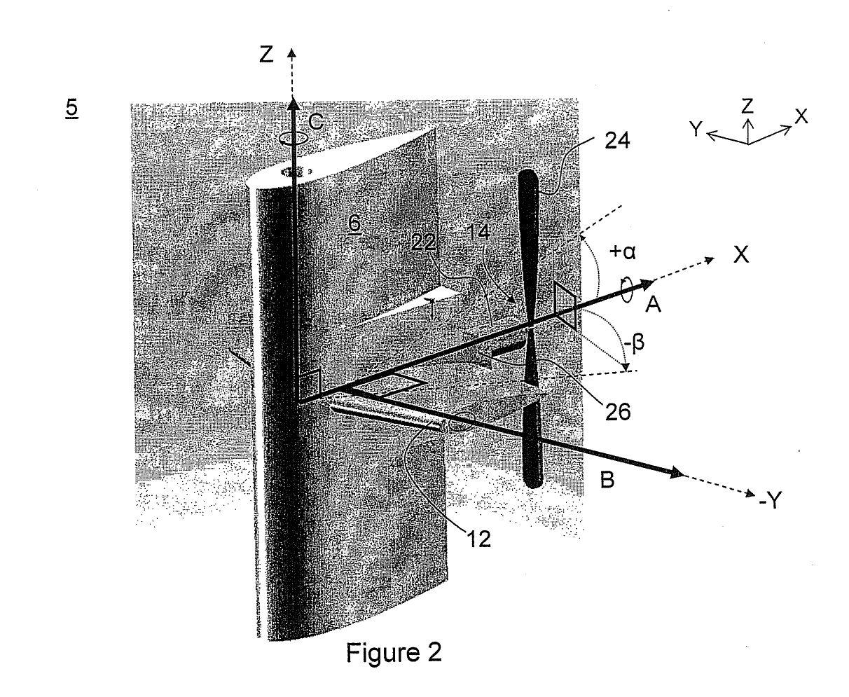

Turning to FIG. 2, a perspective view of an isolated propulsion system 5 is shown in greater detail. The thrust generator 14, in one embodiment shown in FIG. 2, comprises a propeller 24 driven by a motor assembly 22. The motor 22 may be located external to the rudder 6 and elevator 12 to allow the thrust generator 14 to rotate or pitch relative to the rudder 6. In addition to increased range of rotation, placing the motor 22 external to the rudder 6 and elevator 12 reduces the complexity of transferring the motor's energy to the propeller 24. The motor assembly 22 is fixed to a U-shaped bracket 26, and more particularly to the portion that bridges the two armatures of the bracket 26. Each armature on the bracket 26 is situated between the elevator 12 and rudder 6. The bracket 26 is fixed to the elevator 12, wherein the pitch movement of the elevator 12 and, therefore, the thrust generator 14 may be identical. The bracket 26 also positions the propeller 24 further away from the trailing edge of the rudder 6, thereby allowing the thrust generator 14, in this case the propeller 14, to achieve a larger range of pitch rotation. It is appreciated that alternate configurations of the propeller 14, motor 22 and bracket 26 that allow for a sufficient range of rotation are equally applicable.

Also shown in FIG. 2 is an XYZ reference frame that in this example is fixed relative to the underwater vehicle 3 body for the purpose of describing the various configurations below. The XYZ reference frame is oriented such that the X axis is oriented along the length of the vehicle and is directed toward the rear or aft of the vehicle. The Z axis is oriented vertically between the upper body 2 and lower body 4, such that the Z axis is aligned with the vertical length of the rudder 6, and is directed upwards toward the upper body 2. The Y axis is oriented perpendicular to both X and Z axes and, in accordance with chirality, is directed towards the starboard side of the underwater vehicle 3 in this example. This reference may be used to describe the axes of rotation for the above components.

The propeller 24 rotates about the axis A. The axis A, in this case, extends along the length of the bracket 25 and motor assembly 22. The axis A and the elevator 12 both rotate, or pitch, about axis B. It is appreciated that the A axis rotates with the elevator 12 about axis B since the bracket 25 and motor assembly 22 are fixed to the elevator 12. It is further understood that rotational axes A and B remain perpendicular to one another. Axes A and B, and the rudder 6 rotate, or yaw, about axis C.

The three rotational axes, A, B, and C, introduced above, may be described relative to the underwater vehicle's XYZ reference frame. In a neutral orientation, the underwater vehicle's control surfaces are oriented such that the underwater vehicle 3 is directed in a straight heading, with no yawing or pitching movements. In this neutral orientation, the rotational axis A is parallel with the X axis. The A axis is oriented towards the back or aft of the underwater vehicle 3 in the same direction with the X axis, which is also oriented towards the back or aft of the vehicle. In a neutral orientation, the rotational axis B is oriented parallel to the Y axis. However, according to the convention shown here, the positive B axis is oriented towards the portside of the underwater vehicle 3 and the positive Y axis is oriented towards the starboard side of the underwater vehicle 3. The rotational axis C always remains oriented parallel and in the same direction as the vertical Z axis when using this reference frame.

It is noted that the A axis may pitch about the B axis by some angle +/−alpha (α). It is also understood that the thrust from the thrust generator 14 is directed along the A axis. For example, when the A axis inclines above the X axis by +alpha, the elevator 12 and direction of thrust is pitched in a downward direction. Similarly in another example, when the A axis declines below the X axis by—alpha, the elevator 12 and the direction of thrust is pitched in an upward direction. It is further appreciated that when the thrust is directed in along the X axis, then the thrust is directed towards the aft of the underwater vehicle 3, thereby propelling or pushing the underwater vehicle 3 forward.

With regard to the yaw movement, both A and B axes, as well as the rudder 6, may pivot about axis C by some angle +/−beta (β). For example, when the propulsion system or assembly 5 yaws by +beta, the rudder 6 and the A axis rotate from the X axis in a counter clockwise direction. Similarly, the B axis rotates from the −Y axis in a counter clockwise direction by +beta. In yet another example, when the propulsion assembly 5 yaws by −beta, the trailing edge of the rudder 6 and the A axis rotate from the X axis in a clockwise direction, and the B axis rotates from the −Y axis in a clockwise direction. It can be appreciated that the propulsion system 5 may yaw about the C axis by 360 degrees in either a clockwise or counter clockwise direction. As will be exemplified below, such freedom of rotation about the C axis enables complex and controlled movements that provides greater handling and control of an underwater vehicle 3.

The combined movements of the pitch and yaw allows the axis A, and therefore thrust vector, to be oriented in various directions. The combination of the two or more in-line propulsion systems 5 with the described underwater vehicle 3 allow for various manoeuvres with five degrees of freedom, including pitch, yaw, heave (i.e. moving up and down), surge (i.e. moving forward and backward) and sway (i.e. moving left and right).

It may be noted that roll movements may also be achieved if the elevators 12 are controlled to pitch in opposite directions. For example, if the starboard elevators were to pitch upwards and the portside elevators were to pitch downwards, then the underwater vehicle 3 may tend to roll towards the portside.

In another embodiment, not shown, the underwater vehicle 3 comprises at least a first and a second body, whereby the bodies are adjacent to one another and are separated by at least one propulsion system 5. In other words, instead of having an upper and lower body 2, 4 as described above, there is a left and a right body. The underwater vehicle 3 shown in FIG. 1a, for example, would be rolled 90 degrees on to its side. In this orientation, the rudder 6 separating the first and second bodies, or the left and right bodies, becomes an elevator. Similarly, the elevator 12 shown in FIG. 1a becomes a rudder. Therefore, when the underwater propulsion system 5 is oriented on to its side, the rudder 6 functions to control the pitch of the underwater vehicle 3 and the elevator 12 functions to control the yaw of the underwater vehicle 3. It can thus be appreciated that underwater vehicle 3 and the propulsion system 5 may have various orientations and configurations.

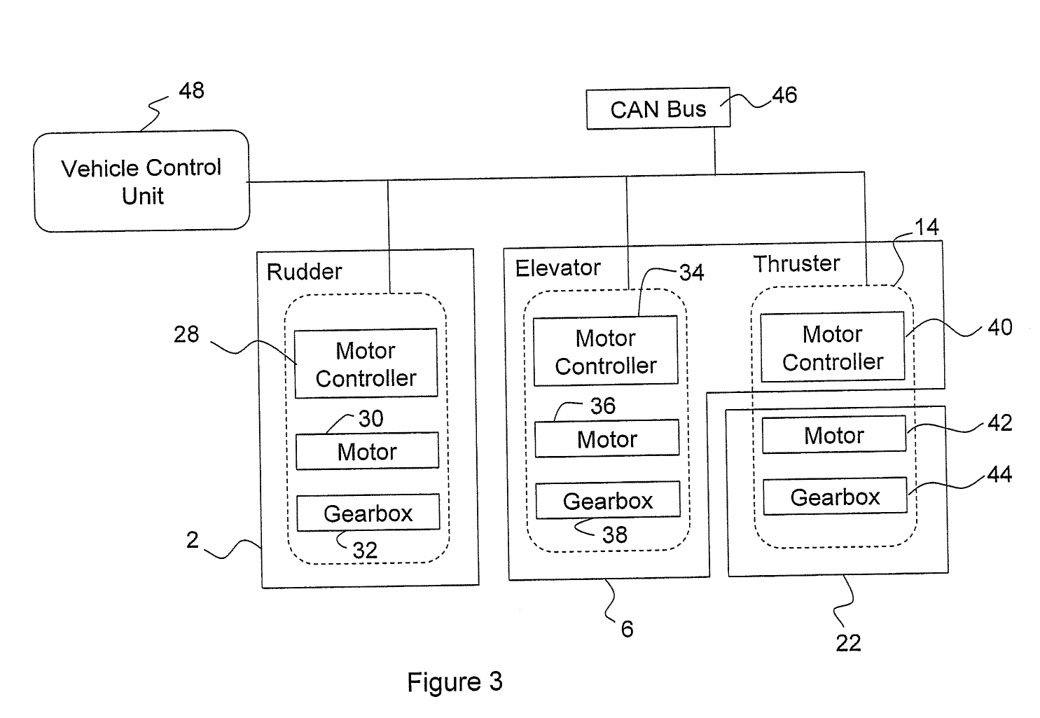

Turning to FIG. 3, the various components in the propulsion system 5 are shown schematically. The rudder 6 subassembly, elevator 12 subassembly and thrust generator 14 subassembly each comprise a motor 30, 36, 42, motor controller 28, 34, 40 and gearbox 32, 38, 44. In general, each motor controller 28, 34, 40 receives signals from a vehicle control unit 48 through a network communication system 46. The motor controller 28, 34, 40 then actuates its corresponding motor 30, 36, 42, which may be coupled to a gearbox 32, 38, 44, to modify the speed and power output of the motor 30, 36, 42.

The vehicle control unit 48 is preferably a computer, housed in the upper body 2 of the underwater vehicle 3, which contains the vehicle's control system software (not shown but can be appreciated as any computer instructions, data structures, memory and other software components stored on and/or accessible from a computer readable medium). It can be appreciated that the vehicle control unit may be housed in lower body 4 as well. Based on navigational sensor input (e.g. GPS, DVL, Altimeter, Attitude Sensor) and using pre-programmed mission criteria, the control system software may calculate the desired vehicle speed, pitch, roll, and heading. Then, based on the current speed, pitch, roll, and heading, the control system sends control information via a network communication system 46, such as a controller-area network (i.e. CAN) bus (as shown in FIG. 3), to the respective motor controllers 28, 34, 40 for each rudder 6, elevator 12 and thrust generator 14 to achieve the desired orientation.

The sub-assemblies in FIG. 3 are indicated by the dashed lines, while the outer solid lines indicate the pressure housings. The rudder subassembly, comprising the rudder's motor controller 28, motor 30 and gearbox 32, is completely contained within its own pressure housing, located in the upper body 2 of the underwater vehicle 3. Components from the elevator and thrust generator subsystem share a pressure housing located in the rudder 6. The elevator's motor controller 34, motor 36 and gearbox 38, as well as the thrust generator's motor controller 40 are located within the pressurized portion of the rudder 6. The thrust generator's motor 42 and gearbox 44 are located external to the rudder 6 and elevator 12 in a separate pressure housing 22 fixed to the end of the bracket 26. The purpose of placing the above components in various pressure housings is to protect the above components from the effects of the water while reducing mechanical complexity.

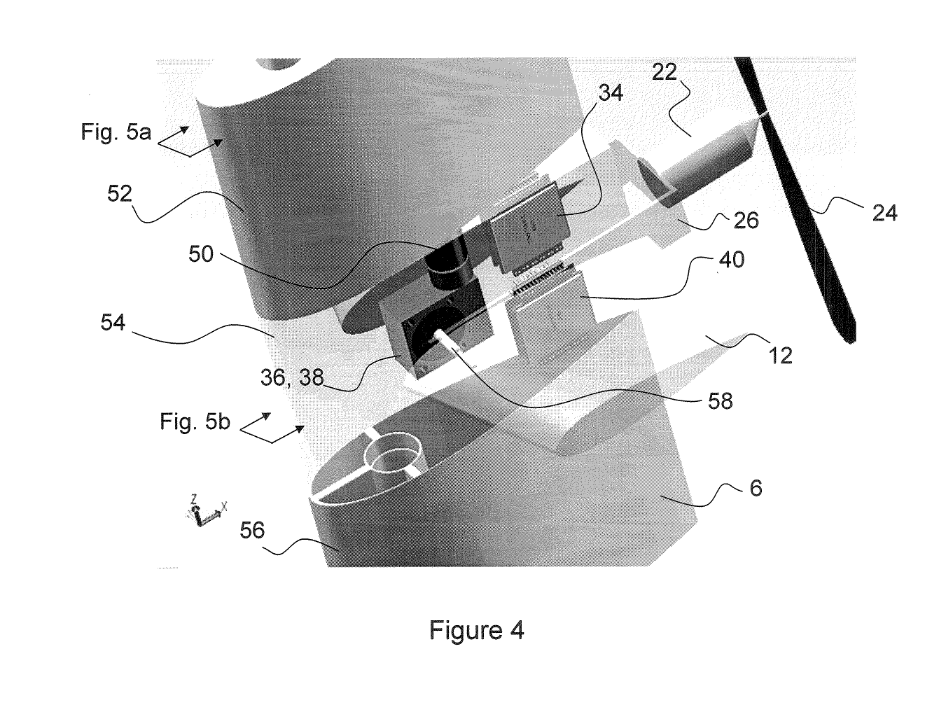

FIG. 4 shows various ones of the above components when housed in the physical structures. In this embodiment, the rudder 6 is divided into three logical and physical sections; the top 52, middle 54, and bottom 56 sections. The top 52 and bottom 56 sections are free-flooding to allow for water to enter and exit freely through designated drainage holes. The drainage holes are positioned in certain areas along the airfoil of the rudder 6 to maintain hydrodynamic efficiency. In one embodiment, the drainage holes may be placed along the top and bottom surfaces of the rudder 6, wherein the top surface is adjacent to the underside of the upper body 2 and the bottom surface is adjacent to the topside of the lower body 4. In other words, the drainage holes are located on a surface of the rudder that faces the hull of the underwater vehicle 3. The middle section 54 of the rudder 6 is pressurized to house the elevator's motor controller 34, motor 36 and gearbox 38, as well as the thrust generator's motor controller 40. The middle section 54 may also be referred to as a pressurized housing. It can be appreciated that the top 52 and bottom 56 sections of the rudder 6 are free-flooding to reduce the effects of dynamic shifting buoyancy forces on the underwater vehicle 3.

Cabling from the upper body 2 to the lower body 4 may also be routed through the hollow shaft 50 around which the rudder 6 rotates. Cabling from the upper body 2 to the respective elevators 12 and thrust generators 14 on the rudder 6 is also routed through this hollow shaft 50 to the components in the pressure housings, which require access to power and the communication network 46.

In this embodiment, the rudder's top 52 and bottom 56 sections are almost identical or mirror images of each other except for one difference pertaining to the joints. The joint from the top section 52 to the upper body 6 contains the motor 30 for rotating the rudder 6, whereas the joint from the bottom section 56 to the lower body 4 contains a bearing to allow for smooth yaw movement.

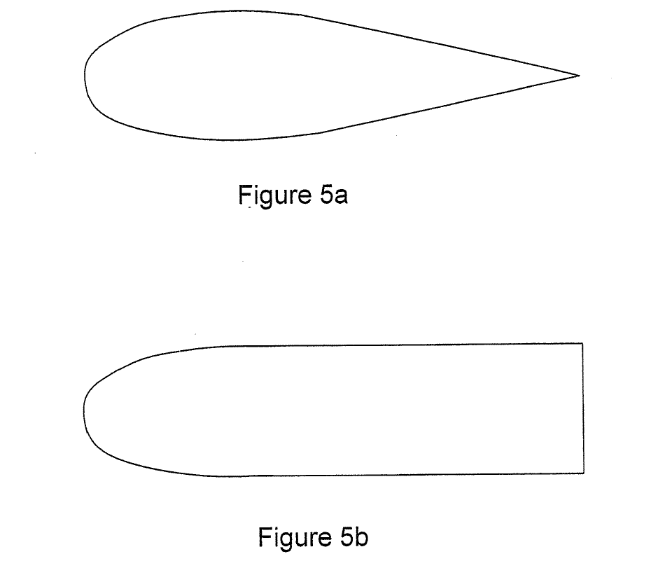

The geometry and functionality of the rudder's middle section 54 differ from the top 52 and bottom 56 sections, although it is mechanically attached to the other two sections. The profile of a top 52 or bottom 56 section, shown in FIG. 5a, comprises a rounded leading edge and a pointed trailing edge. The front face of the middle section 54 is curved to match the nose radius of the airfoil-like profile of the rudder's top 52 and bottom 56 sections. However, as shown in FIG. 5b, the trailing edge portion of the rudder's middle section 54 has a different rectangular profile instead of a pointed edge.

Returning to FIG. 4, the rectangular profile towards the trailing edge increases the volume within the middle section 54 of the rudder 6 and, therefore, allows room for components, such as motor controllers 34, 40, to be stored within the pressure housing. At least one shaft 58 extends horizontally through the middle section, via two waterproof shaft seals, connecting the elevator motor 36 and gearbox 38 to the elevator planes 12. The rotation of the horizontal shaft 58 may cause the elevator planes 12 to pitch. It may be noted that the horizontal shaft 58 corresponds to the rotational axis B. The elevator 12 may be composed of two identical planes, attached on either side of the rudder's middle section 54 via the horizontal shaft 58, as well as the attached bracket 26 used for mounting the motor assembly 22 and propeller 24 aft of the two planes.

FIG. 4 also illustrates where the elevator planes may be connected and aligned together, such that one motor 36 is required to actuate both planes of the elevator 12. A single motor configuration reduces power consumption, reduces complexity and reduces the amount of space required. Alternatively, in another embodiment, the starboard plane and portside plane may each be coupled to their own separate motor for independent control. Therefore, the two separate motors may facilitate rolling movement.

It may be noted that both planes in the elevator 12 do not contain pressure housings, and are free-flooding. Similar to the rudder 6, drainage holes are provided to allow water to enter and exit the elevator 12, and the holes are placed along the elevator 12 to maintain hydrodynamic efficiency. In one embodiment, the drainage holes are placed on the face of the elevator plane 12 attached to the bracket 26 and further, coincident with an identical hole in the bracket 26 itself. This embodiment allows water to enter and/or exit through the drainage holes in the elevator 12, through the coincident holes in the attached bracket 26. The elevator 12 is free-flooding to reduce the effects of shifting buoyancy forces on the underwater vehicle 3. As the elevator 12 extends away from the centerline of the underwater vehicle 3, and pitches and yaws in various directions, the effects of positioning a pressurised housing, or buoyancy generator, may be avoided by flooding the elevator 12 structure. It is noted that the effects of positioning a pressurised housing in the elevator 12 may comprise changes in resulting moments and force vectors acting on the underwater vehicle 3 during various manoeuvres.

FIG. 4 further shows the thrust generator 14, which, in one embodiment, comprises a motor 42 and planetary gearbox 44 mounted inside a hydrodynamic pressure housing for the motor assembly 22, with a sealed bearing connecting the output shaft to a large diameter propeller 24. A cable from the motor assembly housing 22 to the pressurised rudder housing, or middle section 54, connects the motor 42 to the motor controller 40. It can be appreciated that the motor controller 40 is housed in the rudder's pressurised middle section 54 in this example.

The motor assembly 22 and propeller 24 are mounted to the bracket 26, which is mechanically attached to the elevator planes and placed slightly aft of the trailing edge of the rudder 6. The angle of rotation of the elevator 12 is limited to prevent the bracket 26 and propeller 24 from impacting the trailing edge of the rudder 6. Both hard stops, implemented mechanically, and soft stops, implemented in the vehicle control unit 48, may be added to prevent impacts.

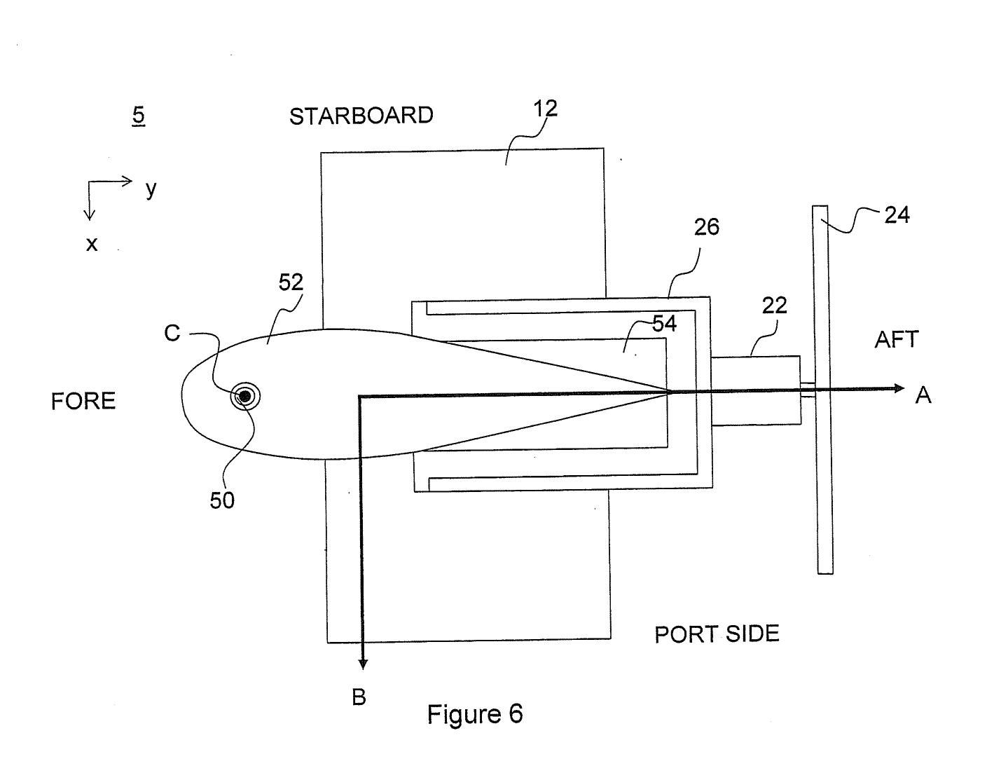

FIG. 6 shows the propulsion assembly 5 from a top planar view. Seen more clearly, the axis A pitches about axis B and yaws about axis C. It is also noted in this embodiment, the pitch axis B may be offset from the yaw axis C. This offset is also reflected in the implementation, wherein the rudder 6 pivots about the vertical hollow shaft 50, which is located towards the leading edge of the rudder 6. The elevator 12 is attachable to the rudder 6 by the horizontal shaft 58, which is located further back from the leading edge of the rudder 6.

In FIG. 6, the profile of the rudder's middle section 54, which comprises a rectangular-shaped trailing edge, is also shown relative to the profile of the rudder's top section 52. In addition, the bracket 26 is shown attached to an inner portion of the elevator 12.

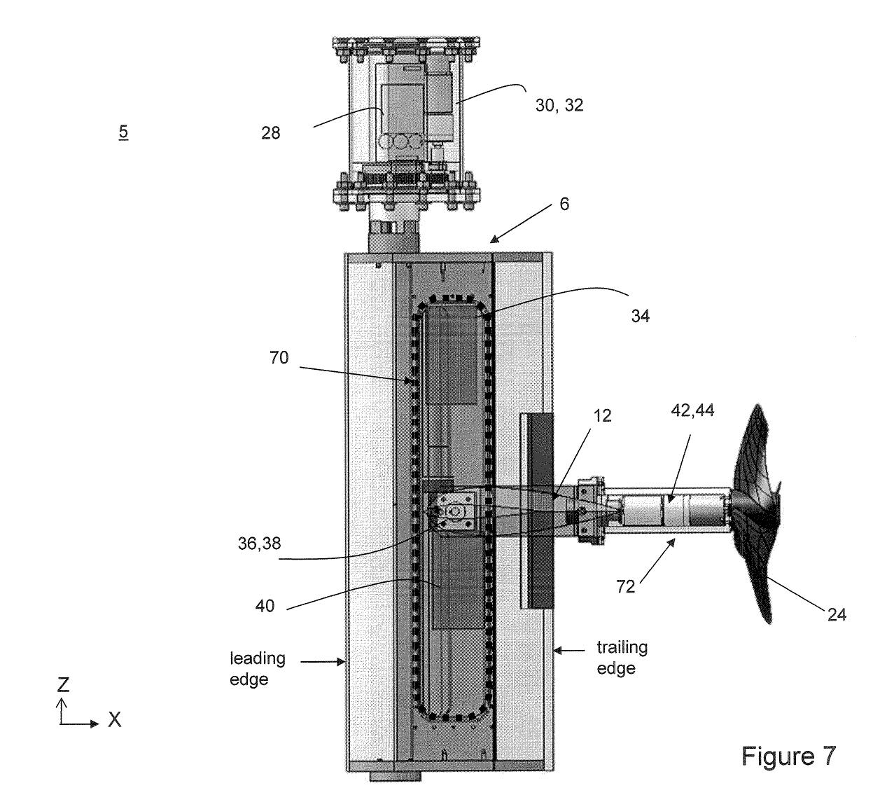

Turning to FIG. 7, another embodiment of an isolated propulsion system 5 is provided. The configuration of the components are different from those shown in FIG. 4. The motor controller 28, motor 30 and gearbox 32 for the rudder 6 are housed separately from the rudder 6, for example, in the upper body 2 or the lower body 4. The motor controller 40 for the elevator 12 is positioned within the pressurized housing 70 of the rudder 6 and, in particular, the motor controller 40 is positioned above the motor 36 and gearbox 38 of the elevator 12. As can be seen, the pressurized housing 70, shown in dotted lines, extends along the length of the rudder 6. The remaining space defined within the rudder 6 may be free-flooded. Also housed within the pressurized housing 70 is the motor controller 40 for the thrust generator 14. In particular, the thrust generator 14, is shown to include a propeller 24 that is mounted towards the end of an tubular housing 72. The tubular housing 72 contains the motor 42 and gearbox 44 for moving the propeller 24. The propeller 24 shown in FIG. 7 comprises three separate blades suited for underwater conditions.

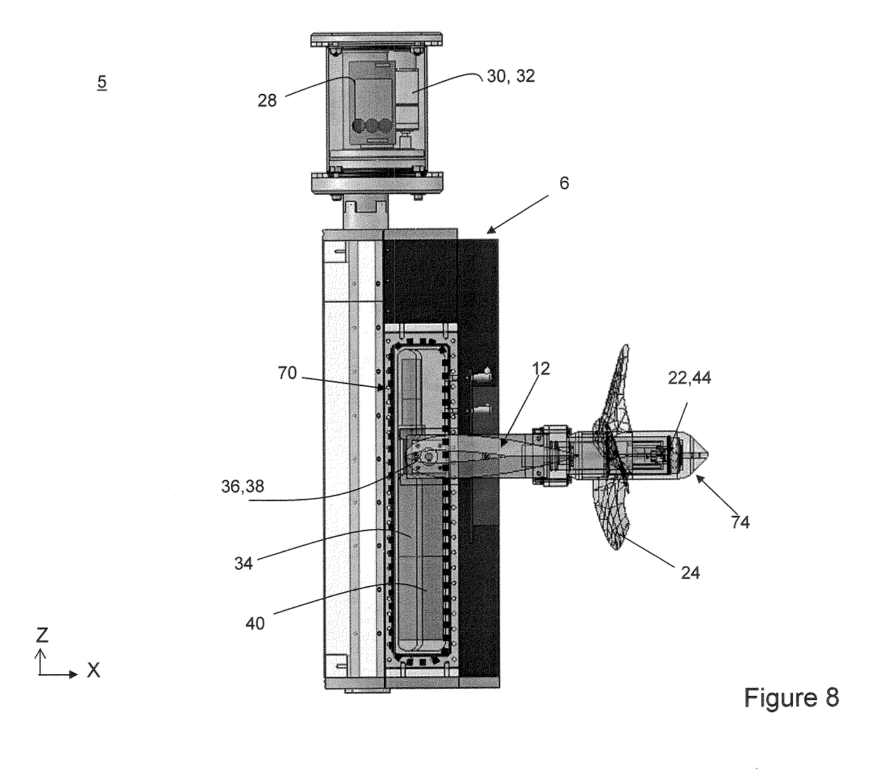

FIG. 8 shows yet another embodiment of a propulsion system 5 in isolation which is similar to the embodiment in FIG. 7. However, in FIG. 8, both motor controllers 34, 40 for the elevator 12 and the thrust generator 14 are located side-by-side in the pressure housing 70. It can be appreciated that the motor controllers 34, 40 may actually reside on a single physical hardware controller capable of implementing computer executable instructions to control the elevator motor 36 and the thrust motor 42. It can also be seen that the propeller 24 is located roughly mid-way along a cylindrical-shaped housing 74. The housing 74 contains the motor 42 and gearbox 44 for moving the propeller 24.

The placement of the propeller 24 roughly mid-way along the length of the housing 74, as shown in FIG. 8, advantageously increases the range of rotation for the elevator 12. In particular, placing the root of the propeller blades toward the end of the housing 72, as per FIG. 7, may lead to the propeller 24 impacting the upper body 2 or lower body 4 when the elevator 12 and thrust generator 14 pitches upwards or downwards, respectively, by a large angle. Therefore, by locating the root of the propeller blades further towards the rudder 6, sometimes also referred to as a “foldback” propeller design, the elevator 12 can be pitched upwards or downwards by a large angle without the propeller 24 impacting the upper body 2 or lower body 4. In this way, the configuration shown in FIG. 8 allows for an increased range of rotation (e.g. pitch) in the elevator 12 and thrust generator 14.

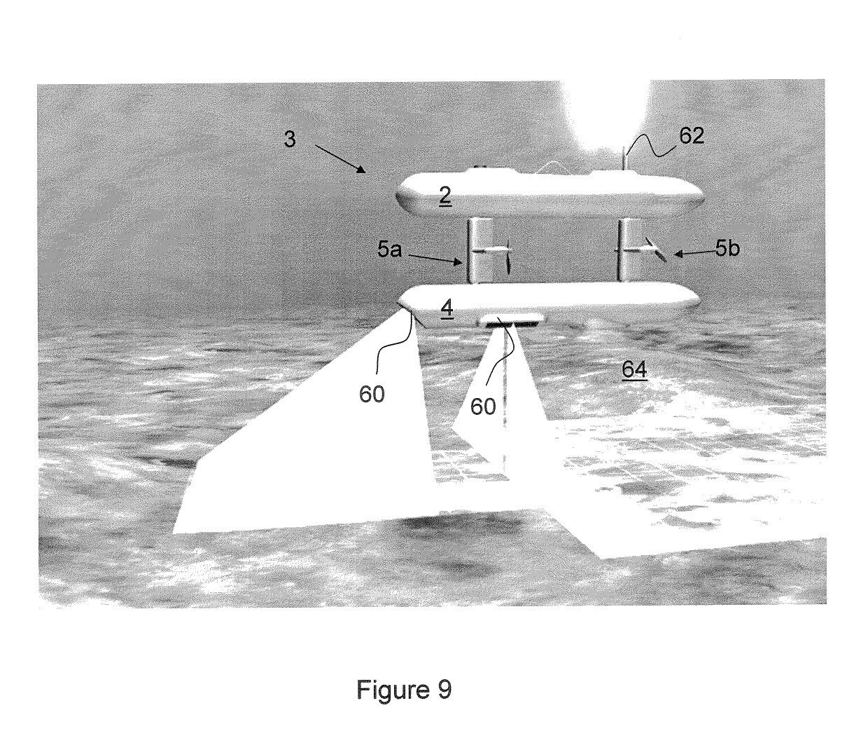

Turning to FIG. 9, one embodiment of the underwater vehicle 3 in an underwater environment is shown relative to a seabed 64. In this embodiment, various sensors 60, for example sonar and imaging equipment, are located in the lower body 4 and may be used to collect data about the seabed 64. Some sensors 60 may be positioned in the lower body 4 to allow for better line-of-sight with the area below the underwater vehicle 3. Other sensors 60 may also be located in the upper body 2. The upper body 2, for example, may house a wireless communications receiver and transceiver 62 to communicate with other marine vessels or a base station. The communications system 62 may relay various information including for example, control commands and sensor data. The communications system 62 may relay command signals to the vehicle control unit 48 to carry out various manoeuvres by orienting the propulsion system in particular configurations.

It has also been found that various ones of these components can be housed in the lower body 4 in order to lower the center of gravity, which assists in the various movements of the vehicle. By way of background, when a marine vessel is tilted the center of buoyancy of the vessel moves laterally. The point at which a vertical line through the tilted center of buoyancy crosses the line through the original, non-tilted center of buoyancy is the metacenter. Lowering of the center of gravity increases the metacentric height, that is the distance between the metacentre and center of buoyancy. A larger metacentric height increases the natural stability of the vehicle in pitch and roll.

It is appreciated that various manoeuvres, many of which utilize the natural stability of the underwater, may be achieved with one or more of the described propulsion systems 5 as described below.

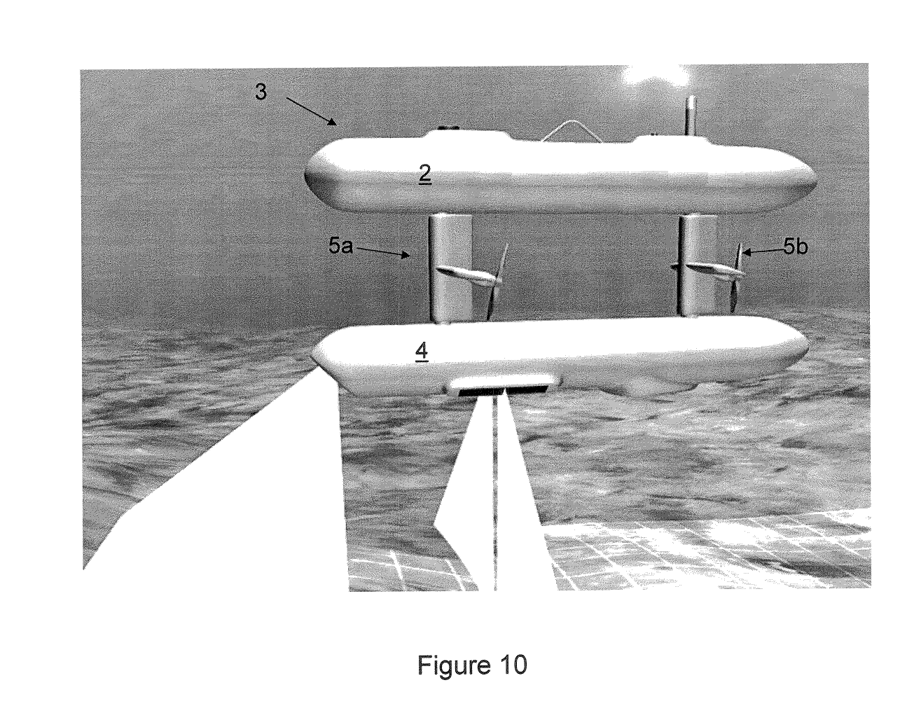

FIG. 10 shows the underwater vehicle 3 with two propulsion systems 5a, 5b. The underwater vehicle 3 is ascending with the length of the bodies 2, 4 being generally parallel with the flat seabed 64, and having a slight pitch. This manoeuvre involves the fore elevator 12a and thrust generator 14a pitching upwards, which causes the nose or front end of the underwater vehicle 3 to move in an upwardly direction. Simultaneously, the aft elevator 12b and thrust generator 14b pitch upwards as well, which also causes the tail or back end of the underwater vehicle 3 to move in an upwardly direction as well. This combined movement of both the fore and aft propulsion systems allows the underwater vehicle 3 to move both forward and upward simultaneously. Alternatively, this manoeuvre may be characterised by pitch, heave and surge.

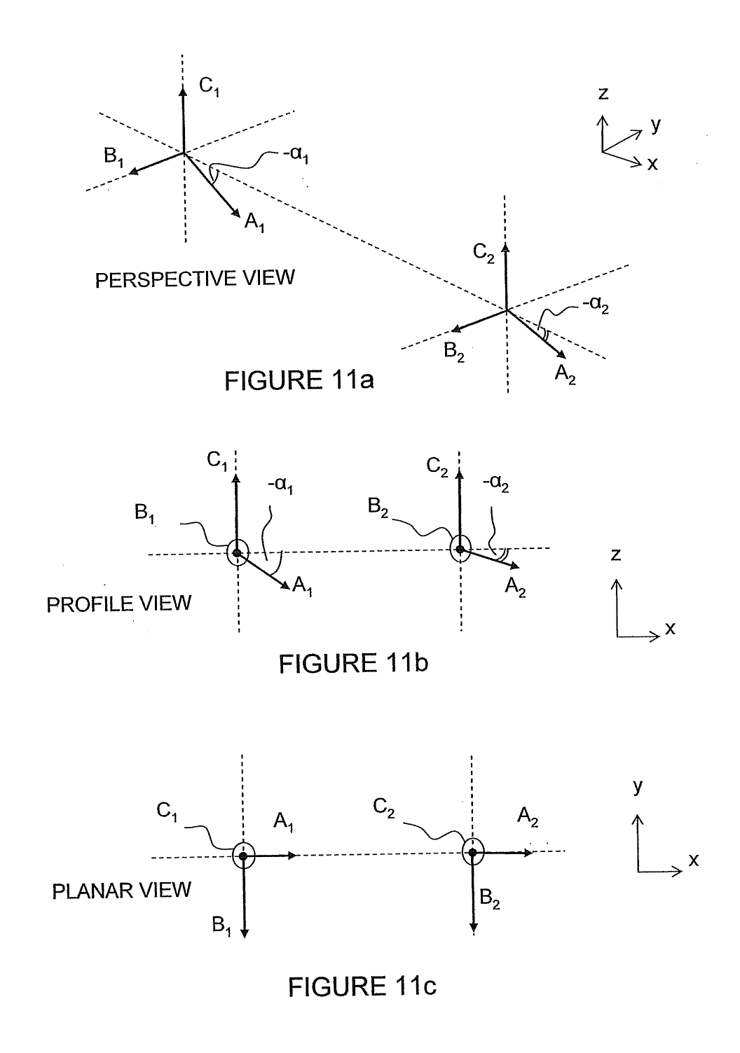

FIGS. 11a to 11c show the perspective view, profile view and planar view of the rotational axes A, B, and C relative to the underwater vehicle 3's XYZ reference frame during an upward and forward ascending manoeuvre, according to FIG. 10. From FIG. 11a, the fore rotational axis A₁ rotates below the X axis by some angle −α₁ degrees, thereby directing the thrust downwards. The aft rotational axis A₂ also rotates below the X axis by some angle −α₂ degrees, such α₂ is slightly less than α₁. Therefore, more thrust is generally directed downwards towards the fore of the underwater vehicle 3 compared to the aft, which may cause the overall underwater vehicle 3 to pitch slightly upwards. The profile view in FIG. 11b also shows that the A axis has a horizontal component direct along the X axis and, thus, the some of the force or thrust from the thrust generators 14a, 14b is acting along the X axis to propel the underwater vehicle 3 forward.

FIG. 11c also shows that no yawing action is involved in this manoeuvre, since the planar view shows that A₁ and A₂ are still aligned with X axis, and B₁ and B₂ are still aligned with the −Y axis. Therefore, rotational angles β₁ and β₂ both equal 0°.

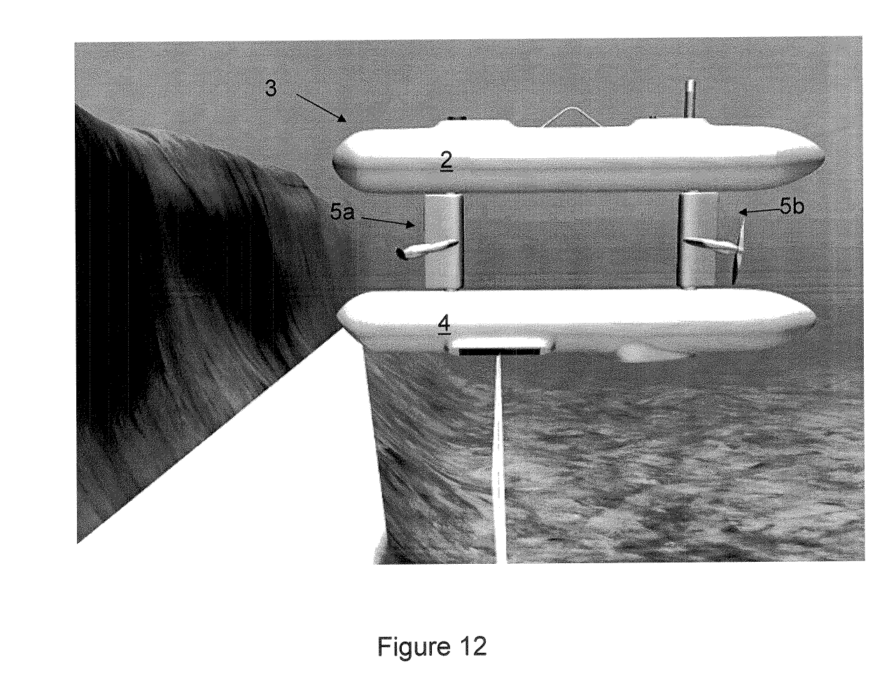

Turning now to FIG. 12, the underwater vehicle 3 is shown carrying out another manoeuvre, such that the underwater vehicle 3 is vertically translating upwards, or heaving, only. There are no yaw, pitch, roll, surge and sway movements. This heave manoeuvre may be useful in various situations. For example, when the underwater vehicle 3 wants to inspect or navigate with respect to the vertical face of an underwater cliff, the underwater vehicle 3 may move upwards and downwards along the height of the cliff while maintaining a fixed horizontal distance from the cliff face.

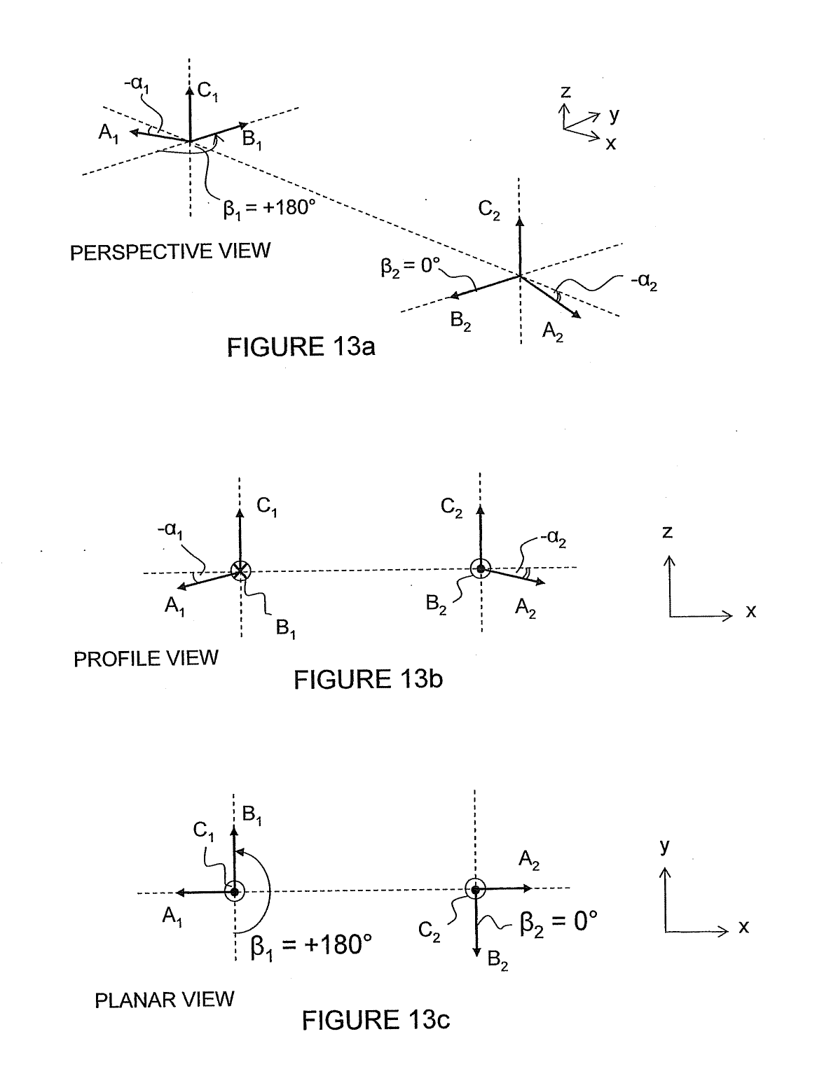

FIGS. 13a to 13c show different views of the orientations of the rotational axes relative to the XYZ reference frame for the heave-only manoeuvre. First, the fore propulsion system yaws 180° about the C axis, such that the leading edge of the fore rudder 6a is directly facing the leading edge of the aft rudder 6b. This yaw rotation is represented by the angle β₁, which equals 180°. As shown in FIGS. 13a and 13c, after the rotation of β₁, the rotational axis B₁ is aligned and pointed in the same direction as the +Y axis. It is noted that the aft propulsion system does not yaw and, thus, β₂ equals 0°.

After the first B₁ rotation, FIGS. 13a and 13b show that the elevator 12 and thrust generator both pitch upwards. Therefore, the A₁ axis rotates below the −X axis in a counter clockwise direction by some angle +α₁, and the A₂ axis rotates below by the X axis in a clockwise direction by some angle −α₂. Assuming the magnitude of thrust is the same from both thrust generators 14a and 14b, the pitch angles α₁ and α₂ are equal in order to cancel out the horizontal forces along the X axis. The horizontal forces cancel each other out since the thrust generators 14a and 14b are directed in opposite directions along the X axis, resulting in only vertical forces. This allows the underwater vehicle 3 to translate vertically upwards.

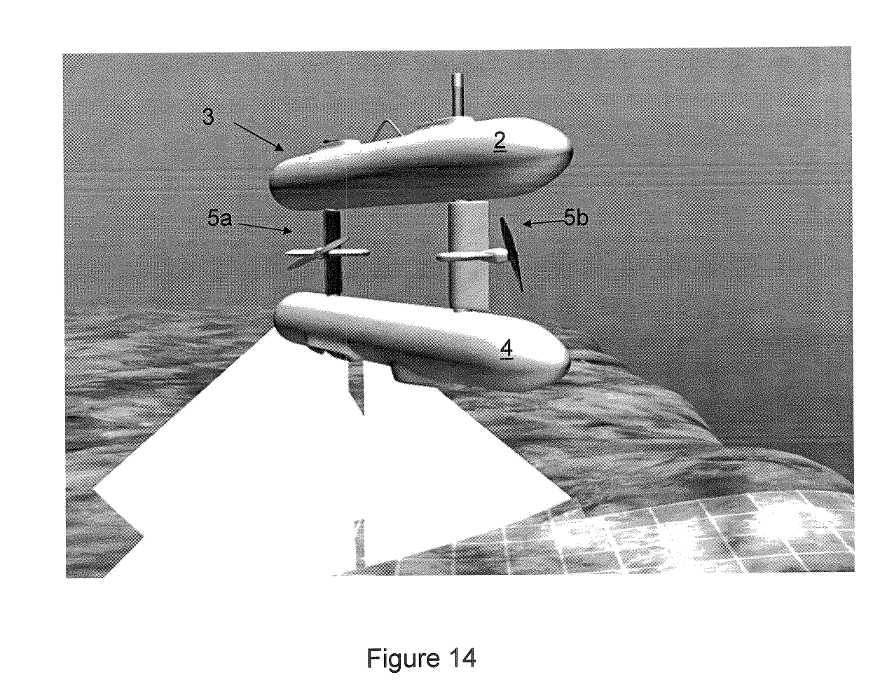

Turning to FIG. 14, the underwater vehicle 3 is shown in the middle of a turn manoeuvre towards the left or starboard side. The two separate propulsion systems located at the fore and aft of the underwater vehicle 3 create a coupled moment about the center of the underwater vehicle 3, which allow for a smaller turning radius. In effect, the underwater vehicle 3 could yaw about a central point with little forward or lateral movement. For example, if the fore rudder 6a directs its leading edge to the face the portside and the aft rudder 6b directs its leading edge to face the starboard side, then the underwater vehicle 3 may rotate or yaw in a counter clockwise direction about a point. This manoeuvrability may be used, for example, to face a forward mounted sensor on the vehicle in an opposite direction while in an environment with constrained space.

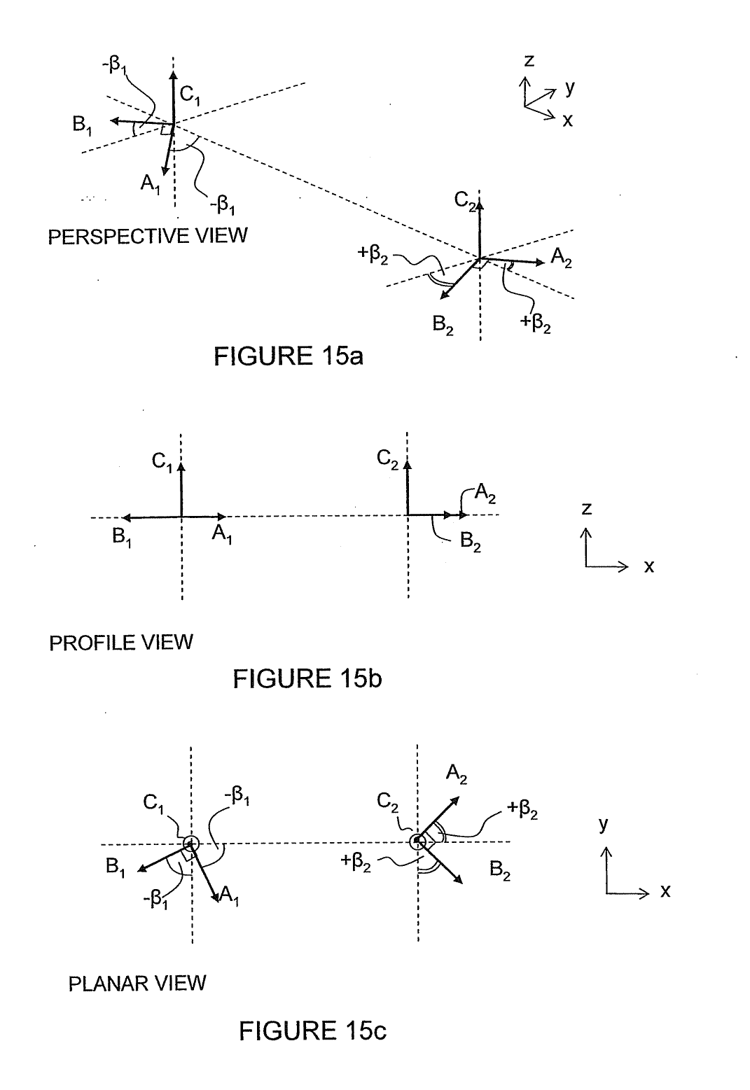

FIGS. 15a to 15c show the different views of the rotational axes A, B and C relative to the underwater vehicle 3's XYZ reference frame for a the starboard turn, according to FIG. 14. It is appreciated that this manoeuvre does not require any pitching motion and, thus, both fore and aft elevators 12a, 12b do not rotate about the B axis. As a result α₁ and α₂ are equal to 0°, as shown most clearly in FIG. 15b.

FIGS. 15a and 15c show the fore propulsion system yawing by some angle −β₁ in counter clockwise direction about the C₁ axis. The rotational axis A1 rotates away from the X axis by −β₁, and the rotational axis B₁ rotates away from the −Y axis by −β₁. It is noted that in this embodiment, the rotational axes A and B remain perpendicular to one another. With this clockwise rotation, the leading edge of the fore rudder 6a is directed towards the starboard side and the thrust is directed towards the portside. This causes the nose of the vehicle to turn towards the right or starboard.

Similarly, the aft propulsion system yaws by some angle β₂ in a clockwise direction about the C₂ axis. The rotational axis A2 rotates away from the X axis by β₂, and the rotational axis B2 rotates away from the −Y axis by β₂. It is noted that in this embodiment, the rotational axes A and B remain perpendicular to one another. With this counter clockwise rotation, the leading edge of the aft rudder 6b is directed towards the portside and the thrust is directed towards the starboard. This causes the tail end of the vehicle to turn towards the left or portside. In this example manoeuvre, the angle β₂ is less than the angle β₁ and, thus, the nose of the underwater vehicle 3 turns more quickly to the starboard than the tail end turns to the portside.

There may be various combinations of pitch and yaw that allow for different movements. For example, if both rudders 6a, 6b direct their leading edges to the left or portside, then the entire underwater vehicle 3 will sway, or laterally translate, towards the portside. This sway movement does not require any yawing rotations. Other movements may include, for example, pitching and yawing simultaneously, or heaving and yawing simultaneously, or moving backwards and pitching simultaneously. In a more specific example, the underwater vehicle 3 may maintain a constant downwards pitch, while moving backwards and side-to-side. Various combinations of pitch, yaw, heave, surge and sway may be accomplished with the propulsion system described herein. Furthermore, with independent starboard and portside elevators, roll may also be achieved. Therefore, the underwater vehicle 3 may move in all six degrees of freedom.

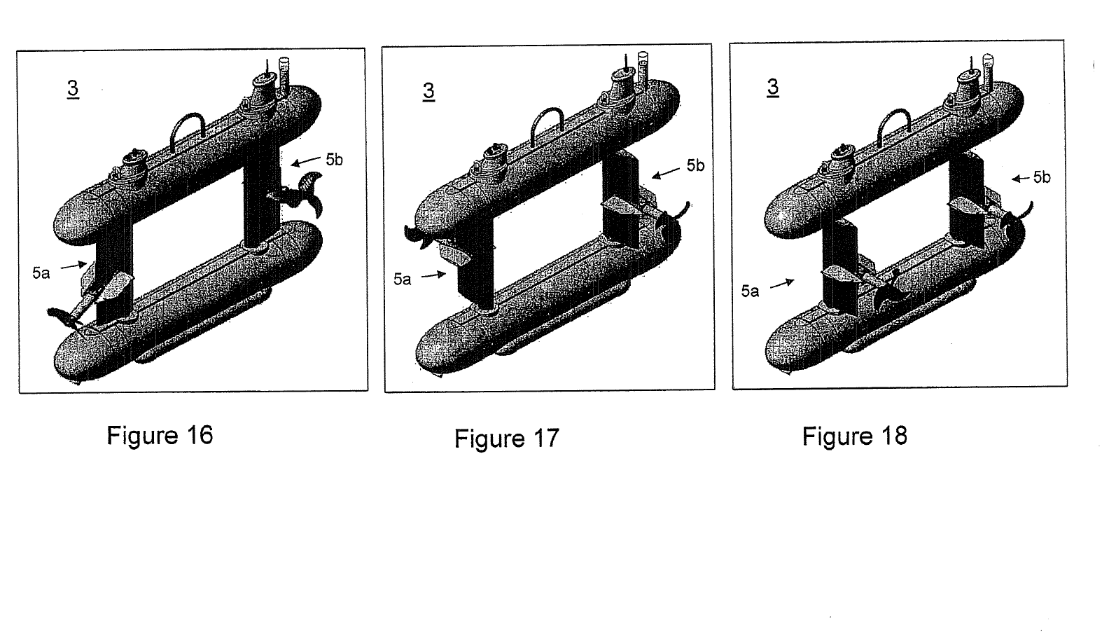

FIGS. 16, 17 and 18 show other configurations of the fore and aft propulsion systems 5a, 5b which allows the underwater vehicle 3 to achieve different manoeuvres. FIG. 16 shows the two propulsion systems 5a, 5b in a hovering configuration, whereby the underwater vehicle 3 is able to heave up or down without swaying, surging or rotating. In particular, the fore rudder 6a has its leading edge directed to the aft of the vehicle 3, and the fore elevator 12a is pitched upwards. The aft rudder 6b has its leading edge directed to the fore of the vehicle 3 and the aft elevator 12b is pitched upwards. FIG. 17 shows the two propulsion systems 5a, 5b in a zero-point radius turn configuration, whereby the underwater vehicle 3 is able to yaw without other types of movement. In particular, the fore rudder 6a has its leading edge directed to the left or portside and the aft rudder 6b has its leading edge directed to the right or starboard. FIG. 18 shows the two propulsion systems 5a, 5b in a swaying or “crabbing” configuration, whereby the underwater vehicle 3 is able to translate laterally without other types of movement. In particular, both rudders 6a, 6b direct their leading edges to the right or starboard.

Another advantage in movement is the underwater vehicle 3's ability to hover, or stay in a fixed position, while maintaining an absolute heading. The propulsion system 5 also allows the underwater vehicle 3 to hover in the presence of currents in any direction and of reasonable speed.

Different manoeuvres may also be achieved by varying the force produced by the thrust generators 14. In one manoeuvre, for example, the fore thrust generator 14 may produce more force during a turn than the aft thrust generator 14b, thereby causing the nose of the underwater vehicle 3 to move at a faster speed. This variable thrust may be generated by increasing or decreasing the speed at which the propeller 24 rotates about the axis A. In addition, the thrust may be varied by controlling the pitch, or angle of attack, or the propeller's blades.

Having two or more of the propulsion systems 5 positioned towards the fore and aft of the underwater vehicle 3 also allows for high manoeuvrability. This configuration encompasses the advantages of both thrust vectoring and differential thrusters. Furthermore, by positioning the two propulsion systems 5 in-line with one another and situated between the upper body 2 and lower body 4, the drag is reduced and hydrodynamic efficiency is maintained.

The configuration of the upper body 2 and lower body 4 also provides the advantage of increased stability with respect to pitch and roll. Separating and placing the lower body 4 below the upper body 2, lowers the center of gravity and provides a higher center of buoyancy.

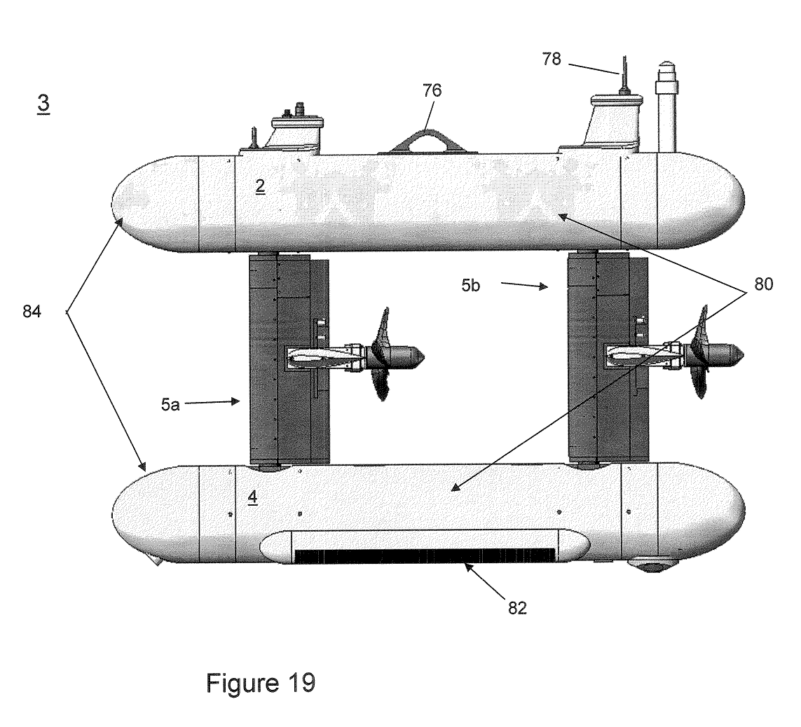

FIGS. 19, 20 and 21 show various views and other components of an embodiment of an underwater vehicle 3. In FIG. 19, the lifting lug 76 is positioned on the upper body 2 and can be used as an attachment point to lift or hoist the entire vehicle 3. One or more antennas 78 are also attached to the upper body 2 and may be used for GPS, radio frequency signals, or other forms of wireless communication. As can be seen, the exterior of the upper body 2 and lower body 4 is covered by a clam shell fairing 80, which is removable to access the inner components. Towards the fore of the vehicle 3, there are nose cone fairings 84 to protect the components found within, as well as reduce drag. There are also side-scan transducers 82 that can be used to measure different aspects of the underwater vehicles environment 3. The transducers 82 may be positioned along the length of the lower body 4.

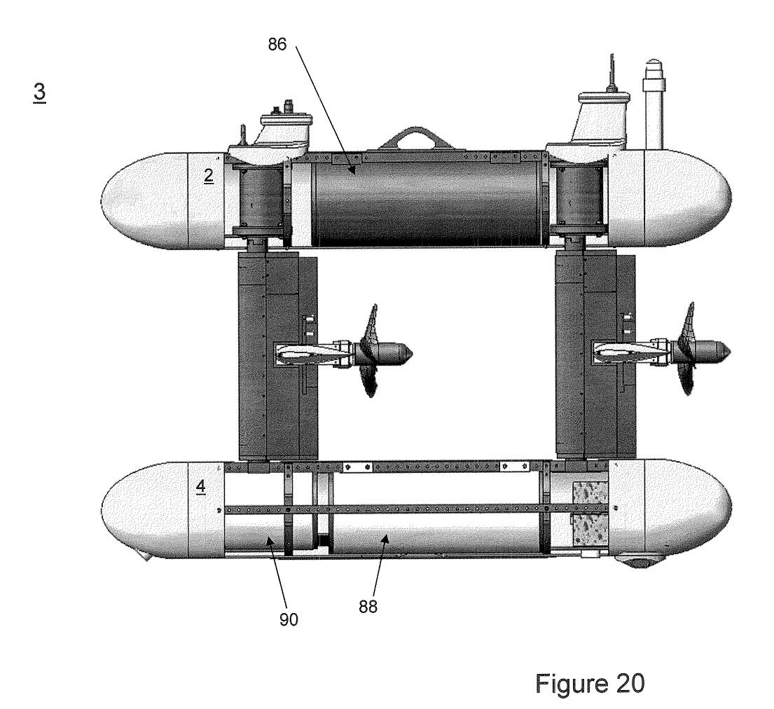

FIG. 20 shows the underwater vehicle 3 of FIG. 19 with the clam shell fairings 80 removed. An electronics housing 80 located at the upper body 2 protects various electrical components. A battery housing 88 is located at the lower body 4 to lower the center of gravity of the vehicle 3 towards the lower body 4. A payload housing 90 is also shown for carrying various materials, for example, sensors.

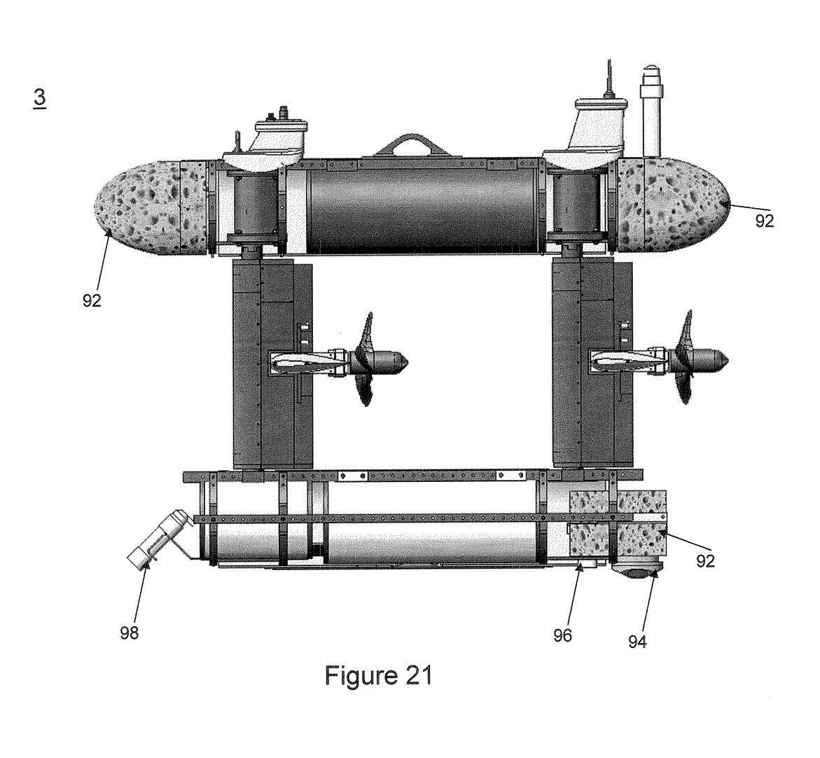

FIG. 21 shows the underwater vehicle 3 without clam shell fairings 80 and nose cone fairings 84. Certain portions of the underwater vehicle 3 include buoyant material 92 to provide additional buoyancy. In particular, buoyant material is located in the fore and aft of the upper body 2, as well as towards the aft of the lower body 4. Examples of buoyant material may include foam, foam products, air pockets, etc. The additional buoyancy in the upper body 4 lowers the center of gravity for the vehicle 3, thereby providing increased roll stability. Located at the fore of the lower body 4 is an obstacle avoidance sensor 98, which may be, for example, of the laser, sonar, infrared, or camera type. An altimeter 96 is also located towards the bottom of the lower body 4. Also positioned in the lower body 4 is a Doppler-type sensor 94, which can be used for determining the positioning of the vehicle relative to its environment. The Doppler-type sensor 94 may be a Doppler velocity Log device.

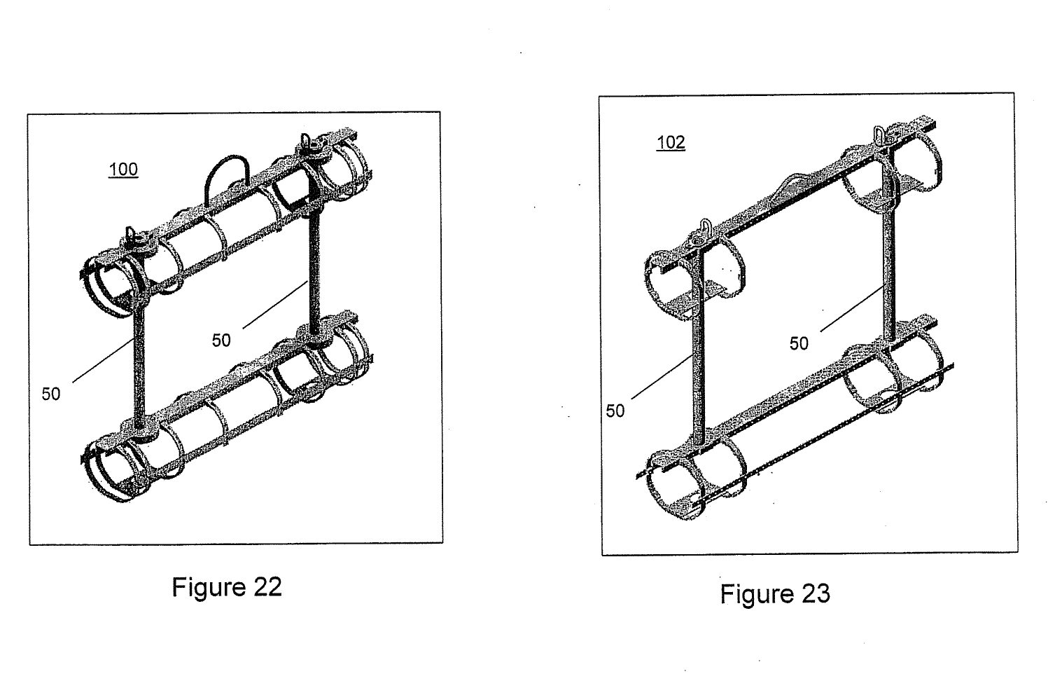

FIGS. 22 and 23 show two separate embodiments of a frame structure for the underwater vehicle 3. In FIG. 22, an embodiment of a frame 100 includes more ribs and thicker material. In FIG. 23, another embodiment of frame 102 includes fewer ribs and thinner material, in order to reduce the weight. The hollow shaft 50, for which a rudder 6 is attached, is also shown.

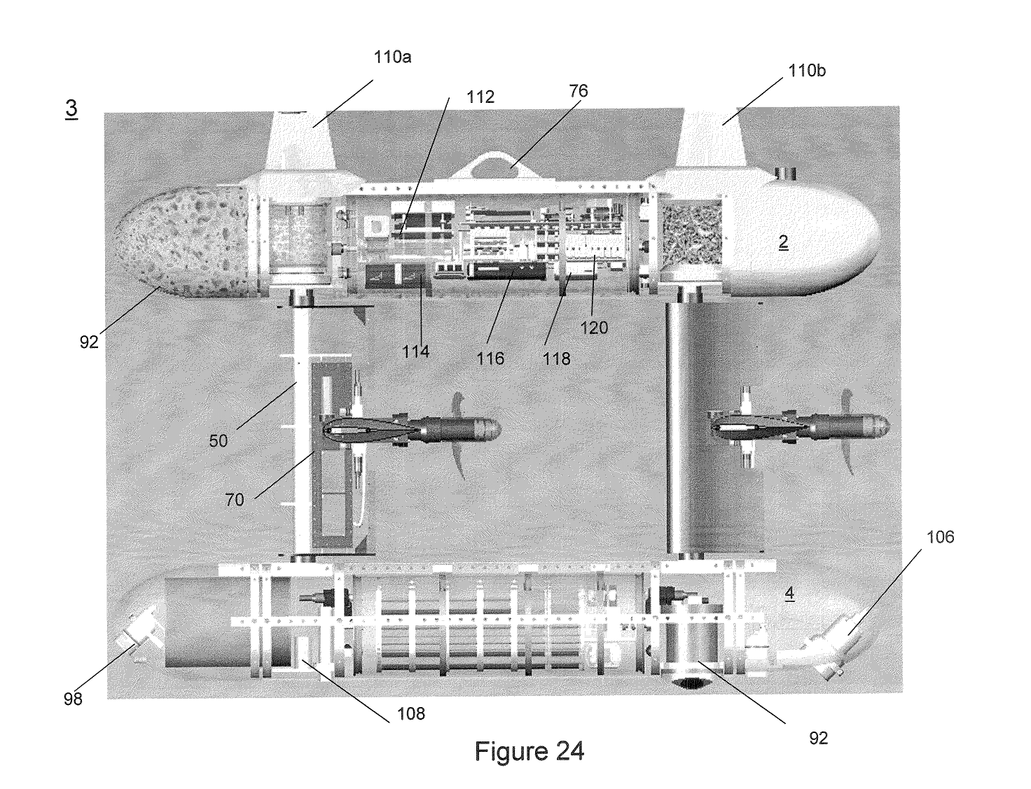

FIG. 24 shows another embodiment of an underwater vehicle 3 whereby a partial cut-away view of the internal components are displayed. A drop weight 108 is located in the lower body 4. It can be appreciated that the drop weight 108 can be released in order to allow the underwater vehicle 3 to ascend more quickly. A camera and a light 106 are located toward the aft of the lower body 4 and are pointed downwards to gather visual data. At the upper body 2, a fore fin 110a and an aft fin 110b protrude upwards for increased stability. Within the electronics housing 86 in the upper body 4, there are various components including a computer 112, emergency batteries 114, a wireless modem 116, a GPS device 118, and an acoustic modem 120. It can be appreciated that various types of electronic devices may be stored and used within the underwater vehicle 3.

The electronics of the underwater vehicle are powered by the main battery 88, which for example is a 48VDC Li-Ion battery pack. There are also separate DC/DC power supplies for various components. Voltage & Current monitoring devices ensure that the electrical components (e.g. motors) are running at normal parameters. A self-resetting fuse is used to protect the propulsion system components, and other electrical systems. For example, CAN-based solid state relays disconnect in the event of a failure or short-circuit. For convenience the batteries 88 and emergency batteries 114 can be charged within the underwater vehicle 3 and may also be swapped with another battery (e.g. a charged battery). Failsafe protocols in the electrical hardware and software may also be used to prevent the electrical system or software from failing. An example of such a protocol is a process for using the emergency batteries 114 should the main batter 88 lose operational capability.

It can be appreciated that the underwater vehicle 3 may be autonomous and able to navigate itself, as well as carry out various other functions (e.g. collecting data, collecting samples, carrying a payload). In another embodiment, the underwater vehicle 3 may be controlled by a pilot positioned within the underwater vehicle 3. In another embodiment, the underwater vehicle may be partially or completely piloted by a remote pilot, who is able to send piloting commands wirelessly or through a tethered cable. One example software architecture that can be used to autonomously control the underwater vehicle 3 is provided below.

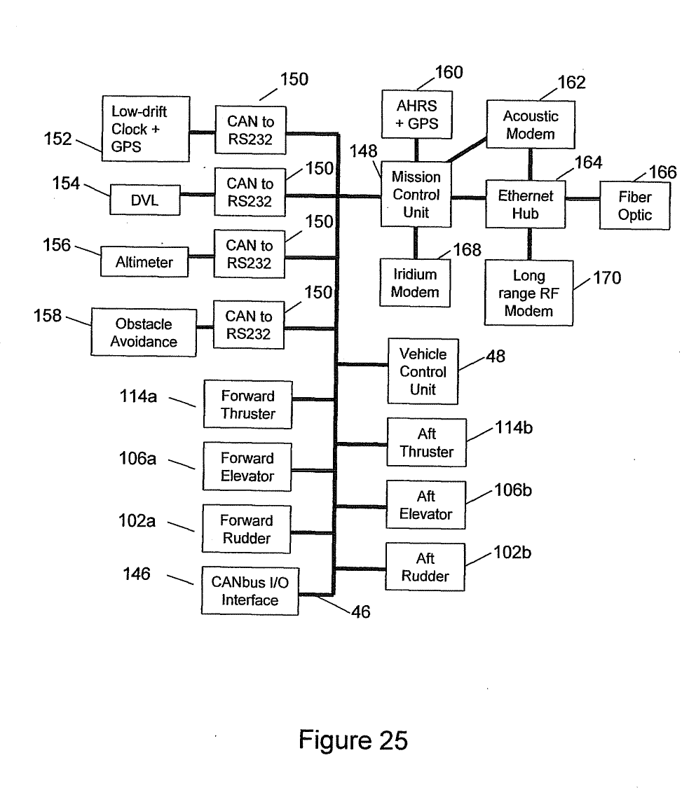

Turning now to FIG. 25, another embodiment of the propulsion control system shown in FIG. 3 is provided. The CAN bus 46 is shown in greater detail and includes a CANbus I/O interface 146 to interface with the actuators associated with the forward and aft thrusters 114a, 114b, the forward and aft elevators 106a, 106b, and the forward and aft rudders 102a, 102b. The VCU 48 is also shown, which is also connected to the CAN bus 46. Also shown in FIG. 17 are a low-drift clock+GPS unit 152, a Doppler velocity profiler (DVL) 154, an altimeter 156, and an obstacle avoidance unit 158, each connected to the CAN bus 46 via a respective CAN-to-RS232 interface 150. A mission control unit (MCU) 148 is also shown, which provides connections to an AHRS+GPS unit 160, an acoustic modem 162, an iridium modem 168, and an Ethernet hub 164. The Ethernet hub 164 can also provide access to a fibre optic unit 166 and a long range RF modem 170.

Shown in FIG. 25 is a modular decentralized architecture that utilizes CAN-based motor controllers (not shown) for each actuator associated with a thruster, elevator or rudder. In this example, fully programmable CAN-based controllers are used to allow for flexible functionality and a high-degree of task-specific customization. Each motor controller typically contains a Flash memory for programming user-defined functions, which may include specific motion control such a differing acceleration and deceleration rates, or custom functionality such as special features or input/output control. In this example, special functions that are particularly useful are for position homing and loss of communication protection. The actuators (not shown) can use a Hall-effect sensor based homing algorithm for absolute positioning, implemented directly on the motor controllers as a user-defined function. When the motor controller is first powered on, this algorithm seeks the range limit of the actuator, defined by the Hall-effect sensors, and calculates the center point between the limits. This algorithm allows for less-costly relative encoders on the motors while still enabling absolute position control of the actuators for the underwater vehicle's control system.

The actuators interface with the VCU 48 through the CANbus interface 146, receiving synchronous set-point commands in the form of CAN messages. If CANbus communications fail, or the VCU 48 software encounters a fault and stops sending commands, the vehicle actuators should respond to prevent damage to the underwater vehicle 3 and the actuators themselves. After evaluating potential solutions, a loss of communication protection algorithm can be implemented on each motor controller. Similar to a watchdog timer (WDT), if the motor controller has not received an updated command within a set time period, if stops the motor and issues a fault message. Since this functionality is localized to the motor controller, each actuator has its own individual protection, independent of the other actuators.

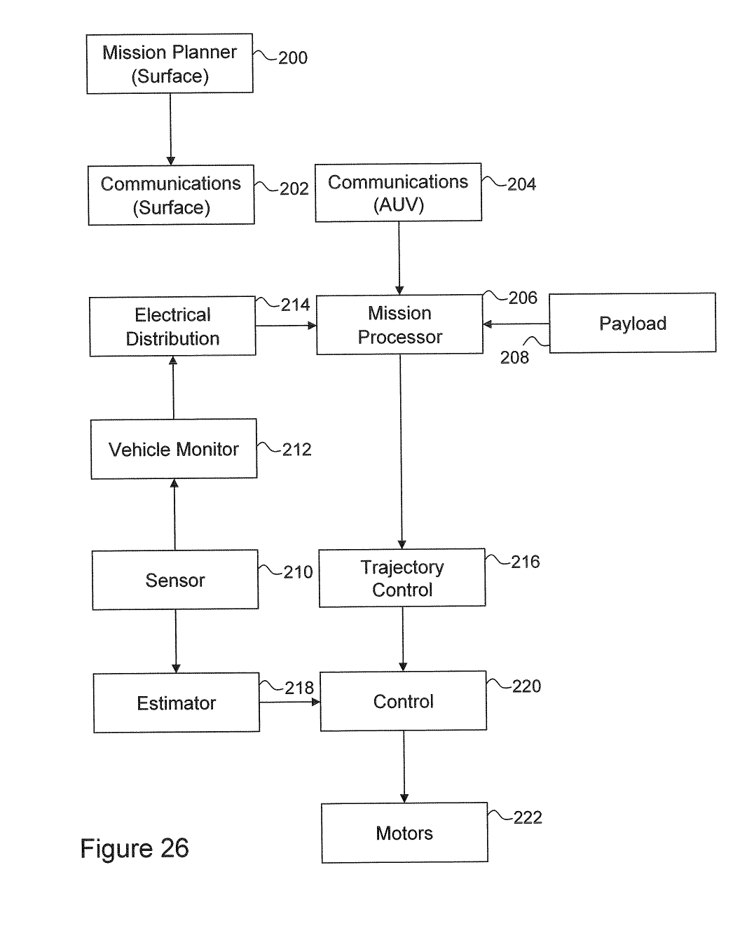

FIG. 26 illustrates the functional modules for one example software architecture for the propulsion control system.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the propulsion control system or accessible or connectable thereto. Any application or module herein described may be implemented using computer readable/executable instructions that may be stored or otherwise held by such computer readable media.

As shown in FIG. 26 a mission planner module 200 is deployed at the surface. The surface mission planner module 200 allows an operator at the surface to control the underwater vehicle 3 manually and to plan missions and download such missions to the underwater vehicle 3 via a surface communications module 202. The mission planner module 200 utilizes or generates a mission plan, which can be in any suitable computer readable format such as an ASCII file to enable the mission to be specified or edited using a text editor. Commercially available mission planning software such as MIMOSA provided by IFREMER (French Research Institute for Exploration of the Sea) or See Track Offshore provided by See Byte Ltd. The mission planner module 200 can use a graphical user interface (GUI)—not shown—designed to enable the operator to enter new missions and monitor the missions from the surface when they are executed. For example, a main display can be used to include a bathymetric map of the area if available. The waypoints in the mission could also be displayed on such a map. Other information such as status parameters of the underwater vehicle 3 could also be provided in the GUI. These parameters may include depth, battery level, communications link status, thruster status, navigation faults, and payload faults.

On the underwater vehicle 3, a vehicle communications module 204 is provided to communicate with the surface communications module 202 to obtain mission plans and to provide status information and other data depending on the application. The vehicle communications module 204 in turn provides the mission plans to a mission processor 206, which extracts a mission profile from the mission plan and generates a list of waypoints from the profile. It can be appreciated that waypoints are sets of coordinates that identify a point in physical space. In one example, a mission profile can define a ladder survey where the underwater vehicle 3 executes a zig-zag pattern over a specified area. The mission profile would include waypoints of an area that should be mapped. In another example, the mission profile can define a pipeline survey where the underwater vehicle 3 follows a pipeline and maps the surrounding area. For such a mission, the approximate location of the pipeline would be specified and the underwater vehicle 3 then descends to this location, searches for the pipeline using on-board capabilities such as a sonar system, and then follows the pipeline. As shown in FIG. 26 a payload module 208 represents a functional module associated with payload such as a sonar system and receives commands from the mission processor 206 to operate the payload and provides the data acquired using the payload back to the mission processor 206.

A sensor module 210 is also shown, which may represent one or more sensors that collect data from various sensors mounted on the underwater vehicle 3. The sensor module 210 passes this data with an associated timestamp to a vehicle monitor module 212 and an estimator module 218. Examples of sensors utilized by the underwater vehicle 3 include GPS, MRU/GPS combination, DVL, altimeter pointing down, altimeter pointing 45 degrees forward, temperature, pressure, etc. The vehicle monitor module 212 monitors the overall vehicle software and status information to ensure that the underwater vehicle 3 is operating correctly. The vehicle monitor module 212 should be able to take action if any vehicle component is not working, e.g. if a navigation failure is encountered, an emergency surfacing of the underwater vehicle 3 can be executed. The vehicle monitor module 212 communicates with an electrical distribution module 214 for controlling power to each individual vehicle electrical component and subsystem through an array of solid state relays (SSRs). The electrical distribution module 214 responds to inputs from both the vehicle monitor 212 and the mission processor 206.

The vehicle monitor module 212 monitors the health and status of all subsystems and components, through software interfaces (e.g. RS232, etc.), current and voltage monitoring circuits, and fault sensors (e.g. leak detectors, ground fault sensors, etc.). If there is a problem with a particular subsystem or component, such as excessive current being drawn, the vehicle monitor module 212 may make the decision to disable that component by sending a command to the electrical distribution module 214 to turn off its relay. Alternatively, there may be a simple software fault, and a component needs to be “reset”, similar to a normal PC, and the vehicle monitor module 212 can also command that action.

The mission processor 206 not only produces waypoints for the trajectory controller for navigational purposes, it also has a higher-level knowledge of the different stages of a mission, and what payloads are required for each stage. For example, while the vehicle is under water, certain systems such as GPS, RF, and satellite communications are no longer able to be used. Thus, the mission processor 206 commands the electrical distribution module 214 to deactivate these certain systems to conserve power. Conversely, while the underwater vehicle 3 is on the surface, it may not require its acoustic modem or USBL systems, and may deactivate those until the appropriate time. Finally, the mission processor 206 will command the electrical distribution module 214 to activate and deactivate payloads as they are needed, depending on the stage of the mission, as payloads tend to be significant power consumers.

A trajectory control module 216 is also provided which obtains the waypoints from the mission processor 206 and generates a smooth trajectory to a desired position. For example, a standard heading tracking algorithm can be used, or if available, an optimal energy trajectory or fast trajectory algorithm can be applied over one or more waypoints. A control module 220 receives set points from the trajectory control module 216 and receives sensor data from the estimator module 218, which calculates the current position, velocity, and attitude of the underwater vehicle 3. The control module 220 uses the set points and the current position provided by the estimator module 218 to calculate an error value between the current position and the position of the waypoint. This error is used to control the motors 30, 36, 42, to move the underwater vehicle 3 to the waypoint. As such, motors module 222 are also provided, which send commands to the motors 30, 36, 42. In the examples shown herein, the motors module 222 would send commands to six different motors, three on each of the fore and aft propulsion systems.

The software architecture herein described should enable the control and estimator modules 218, 220 to run in real-time and should be extendible to accommodate new algorithms. The architecture should also be able to use encrypted communication protocols if required in specific applications, however such details are not shown herein. The operator should be able to change the underwater vehicle's mission while a current mission is in progress, which may require the underwater vehicle 3 to be on the surface and within communication range, or be within range of an acoustic data communications link between the surface and the underwater vehicle 3. The architecture should also have the ability to execute multiple types of missions, e.g. ladder surveys, pipeline surveys, etc. Moreover, the operator should have the ability to start and stop components at runtime, the ability to effect new configuration changes across all components at runtime, the ability to implement new control algorithms on the underwater vehicle 3, and provide usability for different operators having different skill levels.

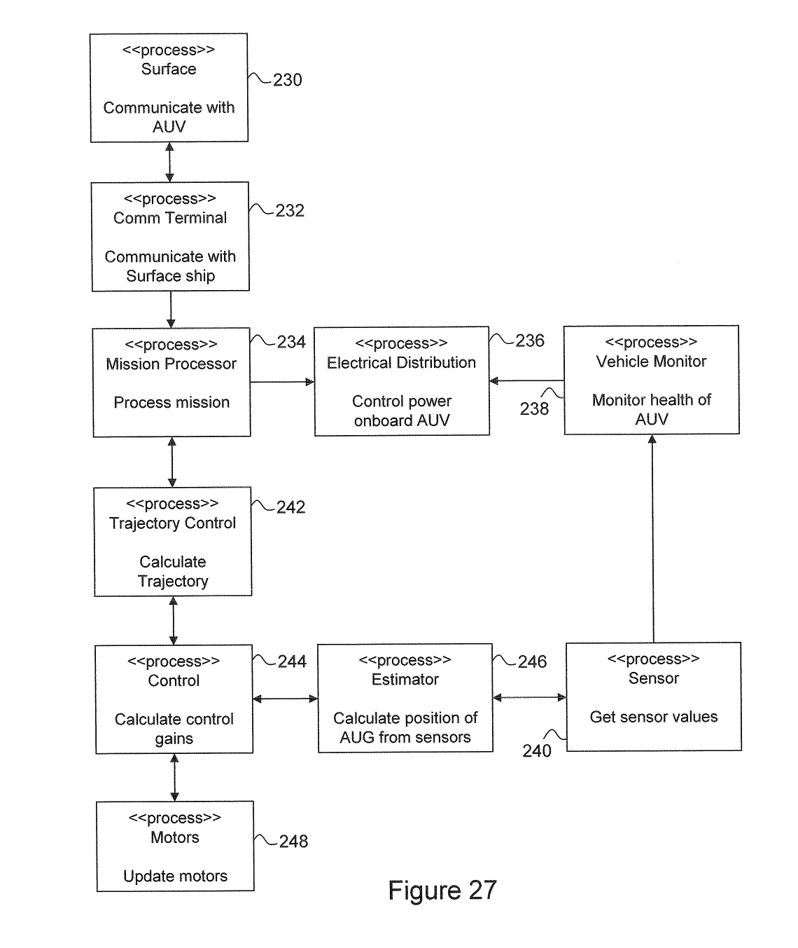

A process diagram is shown in FIG. 27, which illustrates how the various functions and modules shown in FIG. 26 operate together to accomplish a mission. A surface process 230 can be executed to communicate with the underwater vehicle 3 and a communication process 232 can be executed to communicate with a surface ship (not shown). A mission process 234 is then executed to process a mission obtained from the surface ship, which controls power onboard the underwater vehicle 3 using an electrical distribution process 236, and enables the calculation of a trajectory by initiating execution of a trajectory control process 242. A vehicle monitoring process 238 may also be executed to monitor the health of the underwater vehicle 3, which obtains sensor values obtained by a sensor process 240. A control process 244 is executed to calculate the control gains using the calculated trajectory and calculated positions of the underwater vehicle 3 provided by an estimator process 246. To then effect movement of the underwater vehicle 3, the control module then initiates execution of a motors process 248 to update the motors. It can be appreciated that the processes shown in FIG. 27 can be implemented continuously, intermittently, or on demand in order to carry out a mission or to respond to a specific command (e.g. an override from a failure detection system or from the surface ship, etc.).

The surface process 230 runs on a surface computer and allows a user to control and run missions on the underwater vehicle 3. The following Table 1 illustrates various example functions that can be programmed into the software for being executed in the surface process 230.

TABLE 1
Surface Process Functions

| Function | Description |
|---|---|
| initWireless( ) | Initialize communication over wireless modem |
| | (connected by Ethernet) |
| initAcustic( ) | Initialize communication over underwater link |
| initEthernet( ) | Initialize communication over Ethernet (fibre or wire |
| | connection) |
| initSatellite( ) | Initialize communication using Satellite modem. |
| receiveData( ) | Receive data through one of the open and initialized |
| | communication ports. |
| sendData( ) | Send data through one of the open and initialized |
| | communication ports. |
| debugMode( ) | Opens up a terminal to allow direct communication |
| | with the underwater vehicle, via the linux command |
| | line. Recommend to be used only when wired link |
| | between the host and underwater vehicle is used. |
| PlanMission( ) | This function allows the operator to plan a mission for |
| | the underwater vehicle. A graphical user interface over |
| | a map is recommended. |
| ExecuteMission( ) | Send mission to underwater vehicle and start |
| | executing mission. |
| ManualControl( ) | Allows the operator to manually control the |
| | underwater vehicle |

The communication process 232 sets up communication with the surface computer using a modem and an associated communication medium such as wireless, wired, acoustics, etc. The following Table 2 illustrates various example functions that can be programmed into the software for being executed in the communication process 232.

TABLE 2
Communication Process Functions

| Function | Description |
|---|---|
| initWireless( ) | Initialize communication over wireless modem |
| | (connected by Ethernet) |
| initAcustic( ) | Initialize communication over underwater link |
| initEthernet( ) | Initialize communication over Ethernet (fibre or wire |
| | connection) |
| initSatellite( ) | Initialize communication using Satellite modem. |
| receiveData( ) | Receive data through one of the open and initialized |
| | communication ports. |
| sendData( ) | Send data through one of the open and initialized |
| | communication ports. |
| debugMode( ) | Opens up a terminal to allow direct communication with |
| | the underwater vehicle, via the linux command line. |
| | Should be used only when wired link between the host |
| | and underwatervehicle is used. |

It can be appreciated that, depending on communications link available, for data sent via the sendData function, the Time and Health should always be transmitted, and the rest of the data to be transmitted should be selectable by the operator. The following Table 3 illustrates an example format for various data types.

TABLE 3
Data Type Descriptions

| Data | Length | Description |
|---|---|---|
| Time | 9 Bytes | UTC Time hhmmss.sss |
| Health | TBD | Health Status which includes the |
| | | following: |
| | | Battery Status |
| | | Time remaining in mission |
| | | Location |
| | | Motor faults |
| | | Navigation faults |
| | | Payload faults |
| Position | 24 Bytes | Lat, Lon, depth |
| Velocity | 4 Bytes | Current velocity of underwater vehicle |
| Heading | 4 Bytes | Current heading of underwater vehicle |
| Payload Data | Depends on | Sonar image data from payload. |
| | payload | |
| Thruster Power | 8 Bytes | Power of fore and aft thrusters |
| Control Surface | 32 Bytes | Position of fore and aft, rudder and |
| | | elevator planes |
| Raw Sensor Data | TBD | Data from all the sensors on |
| | | underwater vehicle |

The following pseudo code represents example logic that can be used to perform a communication check for all data links.

CommTerminal
StatusWireless = initWireless( ) RF Modem
StatusAcustic = initAcustic( ) Acoustic Modem
StatusEthernet = initEthernet( )
StatusSatellite = initSatellite( )
if (StatusWireless && StatusAcustic && StatusEthernet &&
StatusSatellite == 0 )

Stop AUV mission processes, need communication link to
startup AUV.

else

Default priority of communication links:

1 Ethernet
2 Wireless
3 Acustic
4 Satellite

Send Mission Processor message that communication has been
established.

while(1)

check messages from Mission Processor
if data received from communication link

process data

send UTC and health of available communications link
if communications link not available

for period

attempt to establish communication

end
surface (if in the water)
activate beacon

end

Receive interrupt

Get data from one of the communication links and store in
buffer

Send interrupt

send data in buffer using one of the open communication links

The mission process 234 obtains the mission from the surface and executes it. It also updates the status of the mission, underwater vehicle 3 position and underwater vehicle 3 health to the communication process 232. The mission process can also be used to control the payload 208 (e.g. turns the sonar system on/off depending on the position of the underwater vehicle 3).

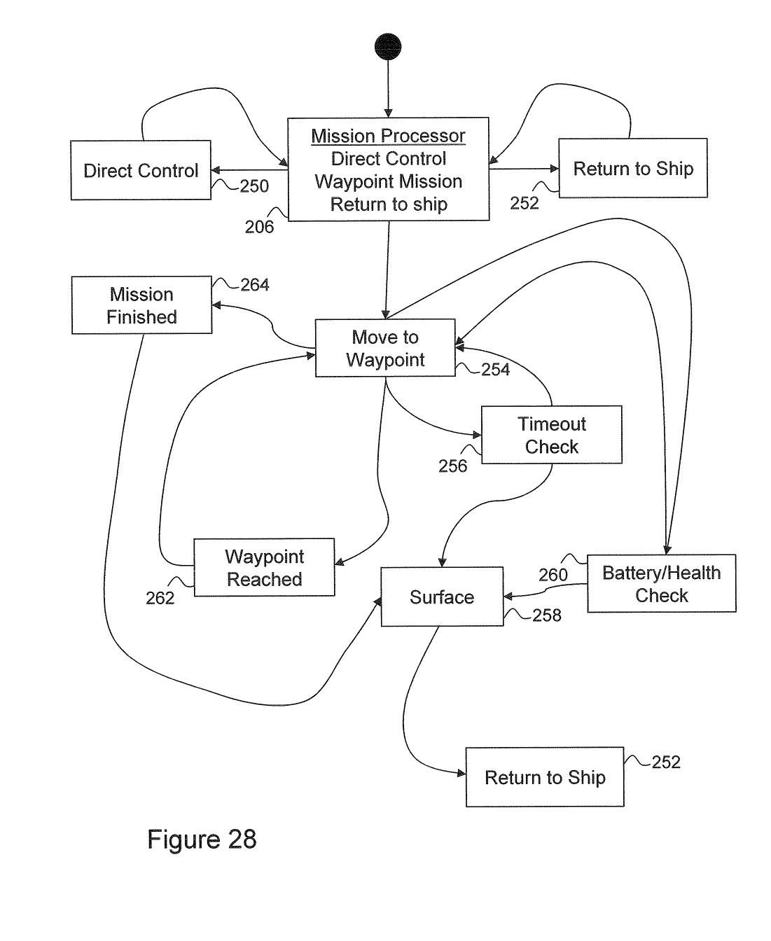

The mission process 234 is typically the first process that is started on the underwater vehicle 3. The mission process 234 then starts the communication process 232 and establishes contact with the host control. FIG. 28 provides a logic diagram illustrating execution of the mission process 234. As can be seen in FIG. 28, in this example, the mission processor 206 executes a direct control process 250, a return to ship process 252, or a move to waypoint or waypoint mission process 254. Under the direct control process 250, commands are sent to the motors and the altimeters can be used to check for obstacles. For the return to ship process 252, the payload 208 is turned off, the underwater vehicle 3 is sent to the surface, the mission processor 206 obtains the current position and obtains a waypoint from the ship to enable it to return to the ship.

The move to waypoint process 254 is used to execute a mission. Until the mission is complete and a mission finished process 264 is executed, the move to waypoint process 254 sends a waypoint list to the trajectory control 216, gets the current position from the trajectory control 216, determines if the payload 208 should be activated (e.g. to obtain data pertaining to the surroundings), maintains the payload 208 at a specified ping rate or turns off the payload. A waypoint reached function 262 determines when the waypoint has been reached and returns to the move to waypoint process 254 to determine the next waypoint in the mission. A timeout check function 256 can be used to determine if too much time has elapsed in order to reach a waypoint. The overall process then returns to the move to waypoint process 254 to recalibrate the trajectory to the waypoint that has not been achieved. If the timeout check 256 indicates that the underwater vehicle 3 has not reached its desired waypoint within a timeout period, then a surface process 258 is executed, which is also executed once the mission finish process 264 is executed. The timeout period is typically calculated or determined during the mission planning stage and is the estimated travel time of the underwater vehicle 3 between waypoints. For example, the timeout period is calculated based on the speed of the underwater vehicle 3, the distance between waypoints, and a percentage error. In another embodiment, if the timeout check 256 determines that the underwater vehicle 3 has not reached the desired waypoint within the desired timeout period, then the underwater vehicle 3 may be programmed to skip the desired waypoint and attempt to reach the next waypoint instead. If it still cannot reach the next waypoint, then it may be concluded that the mission has not been programmed correctly, and the underwater vehicle 3 is attempting to reach waypoints within an unreasonable amount of time, or some other factor is preventing the vehicle 3 from reaching the waypoint. Other factors include, for example, a particularly strong head current that slows down the vehicle 3, or a subsea obstacle entangling the vehicle 3. Examples of subsea obstacles include fishing line, nets, kelp, etc. The surface process 258 can also be executed if a battery/health check process 260 indicates that the underwater vehicle 3 is low on battery power or has some other fault. The surface process 258 then triggers the return to ship process 252 which is shown twice in FIG. 28 for clarity.

The following Table 4 illustrates various mission fault conditions.

TABLE 4
Mission Fault Conditions

| Condition | Description |
|---|---|
| Low Battery | Underwater vehicle battery drops below preset level |
| Mission Timeout | Waypoint not reached within set time |
| Navigation Fault | Navigation sensors stopped updating and estimator |
| | can not calculate position solution initialize |
| Motor Control Fault | Thrusters are not functioning init routines |
| Payload Fault | Payload is not functioning |
| Leak Fault | Fore and aft in top and bottom pressure vessels and |
| | one in payload for a total of 5 sensors |
| Bottom Fault | Bottom detected by forward looking or downward |
| | looking altimeter. |
| Electrical Fault | Fuse or voltage |

The following pseudo-code illustrates an example implementation of the processes shown in FIG. 28.

while(watch dog timer)
{

sendLocation( ) send AUV position to surface
receiveCommand( )
case

command = directControl

send command to Motors
Fore: Rudder, Elevator, Thruster
Aft: Rudder, Elevator, Thruster
Check for obstacles using altimeters

loss of communication protection

stop (set waiting period) and surface

command = waypoint_mission

while mission not complete

send waypoint list to Trajectory control
get current position from TrajectoryControl
check if payload should be activated at this
position
keep payload at specified ping rate
else turnoff payload

relative commands (heading speed)
command = pipefollowing

(low priority)
while mission not complete

get waypoint updates from payload and send

to trajectory control

(relative output, heading - speed)
get current position from TrajectoryControl
check if payload should be activated at this
position
keep payload at specified ping rate
else turnoff payload

command = return home

turn off payload
surface
get current position
set wait for waypoint from ship

command return ship
command emergency surface (for testing faults)

end

}

The above pseudo-code illustrates a “pipefollowing” command, which as can be seen, operates in a manner similar to the “waypoint mission” command but also communicates with the payload 208 to get waypoint updates.

The following Table 5 illustrates various functions that can be called in the software to execute the processes in FIG. 28.

TABLE 5
Mission Process Function Examples

| Function | Description |
|---|---|
| receiveMission( ) | Get mission from surface through communication |
| | process 232 |
| sendLocation( ) | send current location information to surface |
| sendStatus( ) | send underwater vehicle status to surface |
| executeMission( ) | send waypoints to Trajectory Control 216 |
| controlPayload( ) | configure payload and turn payload on/off |

The trajectory control process 242 obtains waypoints or paths from the mission processor 206, and calculates trajectories for the control process 244. The following pseudo-code illustrates an example implementation of the trajectory control process 242.

calcTrajectory( ) - Gets waypoints from MissionProcess and

calculate trajectory get waypoint
case

TrajectoryMode = Goto Waypoint

while waypoints

get waypoint, pass waypoint to Control

Location (X,Y)
Depth (Z) or Altitude mode (exclusive or)
Location tolerance
Depth tolerance or Altitude tolerance
Speed (m/s)
Timeout
Wait for command / get next waypoint

TrajectoryMode = HeadingandSpeed

Heading
Speed
Depth
Time

TrajectoryMode = Follow Path (future development)

List of waypoints passed to Control

TrajectoryMode = Move (while maintaining a set attitude)

(This will be used for complex maneuvers)

Heading
Speed
Pitch
Roll
Yaw
Speed

TrajectoryMode = Station Keep

Send position to Control

Location (X,Y)
Depth (Z) and Altitude (Z)
Location tolerance
Depth tolerance
Pitch
Roll
Yaw

end

As illustrated in the above pseudo-code, in the case where the trajectory mode is go to waypoint, the trajectory control process 242 gets the waypoints and passes them to the control process 244. This can include the location, depth or attitude mode, location tolerance, depth tolerance or attitude tolerance, speed, timeout. The trajectory mode then waits for a command to get the next waypoint. When the trajectory mode is for heading and speed, the heading, speed, depth and time are returned. When the trajectory mode is to move (e.g. while maintaining a specified attitude—complex manoeuvres etc.), the heading, speed, pitch, roll, and yaw are returned. When the trajectory mode indicates “station keep”, the position is sent to the control process 244, which includes the location, depths and attitude, location tolerance, depth tolerance, pitch, roll, and yaw.

The control process 242 obtains waypoints from the trajectory control process 242, and attempts to minimize the error between the target waypoint and current waypoint. The following functions may be implemented: getWaypoint( ); calcPD_Heading( ); calcPD_Velocity( ); calcPI_Depth( ); calcPD_Pitch( ); and calcPI_distance( ). Various control logic can be implemented to be used in the control process 242 as shown in FIGS. 29 to 33.

Turning to FIG. 29, a controller for controlling the pitch of the underwater vehicle 3 is shown. FIG. 30 illustrates a controller for controlling the depth of the underwater vehicle 3. the depth controller is an outer loop around the pitch controller. The pitch controller should run at a faster update rate than the depth controller. The integral module is used in this example to remove the steady state error. The integrator value should have limits to prevent windup.

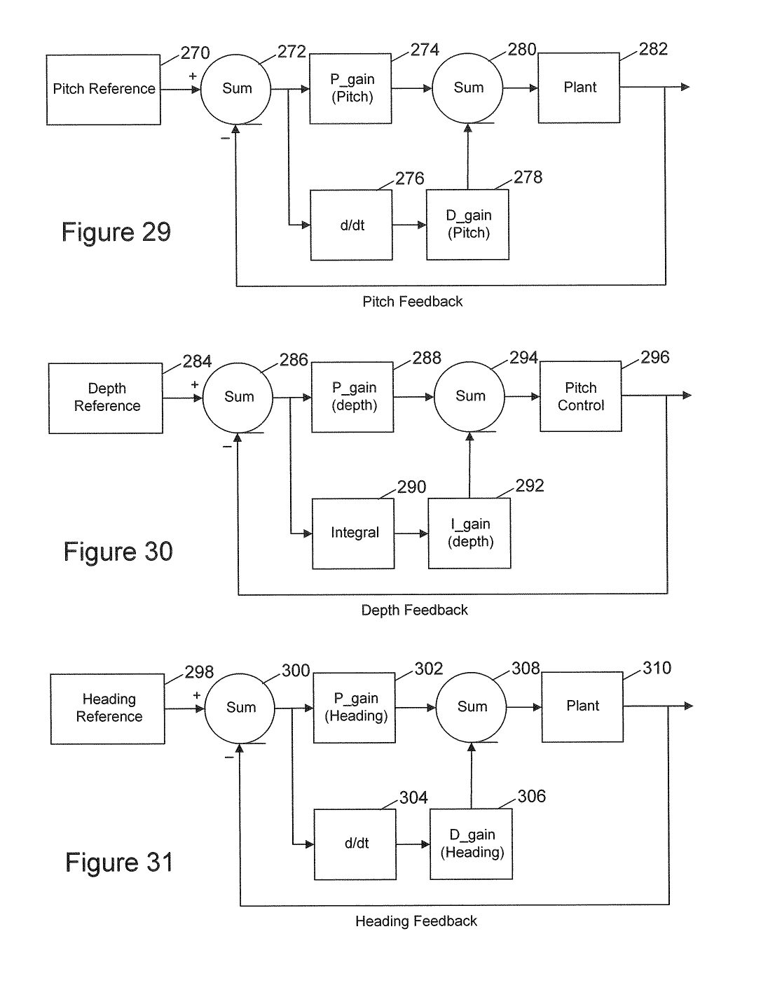

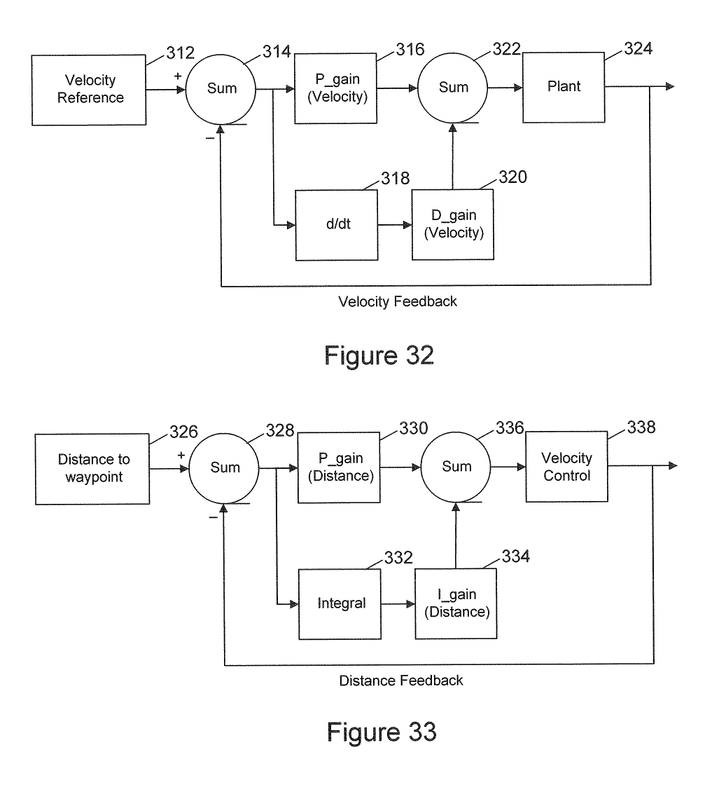

FIG. 31 illustrates a controller for controlling the heading of the underwater vehicle 3 and FIG. 32 illustrates a controller for controlling the velocity of the underwater vehicle 3. FIG. 33 shows a controller for implementing position control based on distance to the next waypoint. The velocity control is the inner loop that runs at a faster rate.

The motors process 248 sends commands to the motors calculated from the output of the control process 244. The following pseudo-code can be implemented for performing speed or torque control.

updateMotors( )

Run motors in velocity control mode
Fore: (pos) Rudder, (pos) Elevator, (speed or Torque) Thruster
Aft: (pos) Rudder, (pos) Elevator, (speed or Torque) Thruster

checkCurrent( )
Activate power to driver side of the motor controller
Turn on motor for operation
Send motor commands
Relays updated only when changed (i.e. at the start)

The estimator process 246 obtains the input from all sensors on the

underwater vehicle. The following functions can be implemented.
initState( )
TimeUpdate( )

integrate gyros to get pitch, roll, yaw
integrate DVL output to get position
update state matrix
update covariance matrix

MeasurementUpdate( )

calculate Kalman gain
updatePitchRoll( ) using accelerometers
update Velocity( ) using DVL
updateHeading( ) using compass
updatePosition( ) using GPS
updateDepth( ) using pressure sensor
update covatiance matrix

The sensor process 240 obtains the actual data from all the sensors. The following functions can be implemented for the sensor process 240: getGPS( ) getMRU( ), getDVL( ), getDepth( ), and getAltimeter( ).

The vehicle monitor process 238 checks the health of the underwater vehicle 3 and takes action if the system fails. The following pseudo-code can be implemented for the vehicle monitor process 238 to perform various example checks on the health and status of the underwater vehicle 3.

while( )

checkEmPower( ) - checks the battery emergency battery power and

reports voltage

checkPower( ) - check main battery power and reports voltage,

capacity estimate, current measurement (fore and aft propulsion, battery,
12V bus)

checkGroundFault( ) - checks for ground fault
checkDepth( ) - checks the depth of the vehicle and if it is below

a preset point sets alarm

checkIMU( ) - checks that IMU is outputting valid data
checkLeaks( ) - checks for leaks
activateEmergancySurface( ) - turn thrusters off and drops weight
detectShort( ) - checks power draw, if above preset value turn off
master power switch and activateEmergancySurface

The following describes the various interfaces internally between tasks and externally to sensors and communication links. All the external communications to the sensors, motors, etc. over RS232, CAN bus or Ethernet are specified below to illustrate the communication interfaces and protocols for implementing the example shown in FIG. 25. The internal communications between tasks are also described.

A suitable altimeter 156 has the following communication specifications: RS232, 115200 bps, No Parity, 8 Data bits, 1 stop bit. The altimeter 156 should respond to a “Switch Data” command at which the head transmits, receives and sends its return data back to the command program. To prevent interference with the payload (in particular when sonar), the DVL 154 should be run in a “command step” mode where once a start command is received by the DVL 154, the system will ping and output the result only once. For the transmit power, an auto mode should be used where the DVL 154 automatically adjusts its transmission power in the process of a deployment. The DVL 154 is typically deployed with the transducer facing down. The speed of sound which may be required for certain calculations is known to vary according to the current environment in the water. Therefore, the speed of sound can be determined either from user input (e.g. from reading tables or using another available source) or by calculating the speed of sound using depth, temperature and salinity measurements.

The Table 6 below illustrates an example output format which, for example, may use the WH PD4 compatible binary output.

TABLE 6
Output Format Example

| Byte | Value | Meaning |
|---|---|---|
| 0 | 0x7D | Id |
| 1 | 0x00 | PD4 frame |
| 2 & 3 | 0x00000 | Not used |
| 4 | 0x00 | System conf |
| 5 & 6 | 16 bit signed integer | Transverse vel (mm/s) bottom track |
| | (LSB/MSB) | (Pos. toward starboard) |
| 7 & 8 | 16 bit signed integer | Longitudinal vel (mm/s) |
| 9 & 10 | 16 bit signed integer | Vertical vel (mm/s) |
| 11 & 12 | 0x0000 | Not used |
| 13 to 21 | 0x0000 | Not used |
| 22 & 23 | 16 bit signed integer | Transverse vel (mm/s) water track |
| | | (Pos. toward starboard) |
| 24 & 25 | 16 bit signed integer | Longitudinal vel (mm/s) |
| 26 & 27 | 16 bit signed integer | Vertical vel (mm/s) |
| 28 & 29 | 0x0000 | Not used |
| 30 to 46 | 0x0000 | Not used |

Inertial instrumentation may also be used. The selected communications mode should be the one that can output raw data from the gyros, accelerometers and magnetometer at the fastest update rate possible. Below is the example for an inertial sensor. A standard communications structure is as follows in Tables 7 and 8 but it can be appreciated that other structures may be implemented depending on the equipment used:

TABLE 7
Communications Structure

| | | | | | |
|---|---|---|---|---|---|
| PRE | BID | MID | LEN | DATA | CS |

TABLE 8
Communications Structure Field Descriptions

| Field | Field width | | Description |
|---|---|---|---|
| PRE | 1 | byte | Preamble, indicator of start of |
| | | | packet 250 (0xFA) |
| BID | 1 | byte | Bus identifier/address 255 |
| | | | (0xFF) |
| MID | 1 | byte | Message identifier |
| LEN | 1 | byte | Value equals number of bytes |
| | | | in DATA field Maximum |
| | | | value is 254 (0xFE). Value |
| | | | 255 (0xFF) is reserved. |
| DATA | 0 to 254 | bytes | Data bytes (optional) |
| CS | 1 | byte | Checksum of message |

In the following, further implementation details are provided to further illustrate the present example.

When underwater with no GPS, position can be calculated by integrating MRU gyros and accelerometers with corrections obtained from a compass (heading), an altimeter (z position), depth (z position) and DVL (velocity). The MRU provides the following measurements having the following units: acceleration: accel_x, accel_y, accel_z (m/s/s); gyro rate: rate_x, rate_y, rate_z (rad/s); and magnetic: mag_x, mag_y, mag_z (mgauss). The GPS provides the following data: latitude, longitude, velocity (m/s), and heading (deg) (when available). The altimeter 156 provides the distance from bottom (m), and the pressure gauge indicates depth (m). The DVL 154 measures vehicle velocity (relative to seabed), projected into the body coordinate system. Bottom track velocity data is as follows: transverse velocity (mm/s) (positive toward starboard); longitudinal velocity (mm/s); and vertical velocity (mm/s). Water track velocity data is as follows: transverse velocity (mm/s) (positive toward starboard); longitudinal velocity (minis); and vertical velocity (mm/s).

An inertial navigation system (INS) can be used which calculates position, velocity and attitude using high frequency data from the MRU, which comprises of three accelerometers, three gyros and a three axis compass. The INS is aided by the DVL 154, depth gauge and altimeter. The INS is initialized on the surface using the GPS. Gyros can be integrated and corrected by the compass and accelerometers (e.g. using an extended Kalman filter). The DVL 154 is used to correct the velocity from the integrated accelerometers, which helps calculate the gravity vector, which can be subtracted from the accelerations so that body acceleration can be calculated. Position is calculated using the DVL 154, attitude and integrated accelerations.

A north, east, down navigation frame should be assumed where north points toward the bow (front) of the underwater vehicle 3, east points starboard (right), and down points down. Rotations are right hand rule where the thumb points in the direction of the axis. Misalignment angles between the INS and DVL 154 should be accurately calibrated. For INS/DVL navigation, the 17 state vector that we want to estimate in this example is defined as:

\hat{x}=[q₀q₁q₂q₃vₓv_{y}v_{z}ρₓρ_{y}ρ_{z}gbₓgb_{y}gb_{z}abₓab_{z}ab_{z}g]

The states are as follows:

q₀,q₁,q₂,q₃—estimated attitude represented in quaternion format.

vₓ,v_{y},v_{z}—estimated velocity.
ρₓ,ρ_{y},ρ_{z}—estimated position.
gbₓ,gb_{y},qb_{z}—estimated gyro bias.
abₓ,ab_{y},ab_{z}—estimated accelerometer bias.

g—gravity magnitude.

The system can be described by the following nonlinear differential equations:

\dot{x}=f(x)+w

z=h(x)+v

The first equation is the state update equation where x is the vector of states, f(x) is a nonlinear function of the states and w is a random zero mean process. The noise process model is Q=E(ww^{T}).

The second equation in the measurement update where v is a zero-mean random process described by the measurement noise matrix R which is defined as R=E(vv^{T}).

The measurement equation in discrete form can be written as zₖ=h(xₖ)+vₖ.

The system and measurement equations are nonlinear, therefore a first order approximation is used for the system dynamic matrix F and the measurement matrix H.

$${{F = \frac{\partial f ( x )}{\partial x} \vert}_{x = \hat{x}} \\ H = \frac{\partial h ( x )}{\partial x} \vert}_{x = \hat{x}}$$

The fundamental matrix for the discrete Riccati equations, can be approximated by the Taylor series expansion for exp(FTs): Φₖ≈I+FTₛ. The first step is to initialize the initial states, this would be done while the underwater vehicle 3 is on the surface. The attitude quaternions are initialized by taking the measurements over a specified start up period while the underwater vehicle 3 is as still as possible from the accelerometers to calculate a gravity vector, the compass to get heading and the GPS to correct the accelerometers for motion. The initial velocity should be near zero, if not if would be initialized from the GPS. The position will also be initialized from the GPS. The gyro bias and accelerometer bias would be initialized by integrating the gyro and accelerometer respective outputs over the start up period.

Once the estimator is initialized there are two main parts to the estimator time update which will constantly update the states at a specified rate and the measurement update which will be done when measurements are available from different sensors. The gyros, accelerometers and DVL 154 are integrated to give position and orientation estimate. To get an accurate estimate of the attitude and position of the underwater vehicle 3 the drift from the gyros and accelerometers should be corrected for using external measurements from the compass, DVL 154, USBL, altimeter and depth gauge.

For a time update, first the system state vector is updated:

\hat{x}ₖ₊₁=Φₖxₖ=\hat{x}ₖ+FTₛ\hat{x}ₖ.

Then the covariance matrix is updated: Pₖ₊₁=Pₖ+Tₛ(FₖPₖ+PₖFₖ^{T}+Q); where:
F—system matrix.
Q—process noise matrix.
P—covariance matrix.
xₖ—current state.

For a measurement update, the measurement update equations are calculated when a measurement is available. In the underwater vehicle 3 case, the measurement would be from the DVL, USBL, altimeter or depth gauge pressure sensor. For each different sensor the measurement matrix H will have to be calculated along with the following equations:

Kₖ=PₖHₖ^{T(}HₖPₖHₖ^{T}+R)⁻¹

\hat{x}ₖ₊₁=\hat{x}ₖ+Kₖ(zₖ−H\hat{x}ₖ)

Pₖ₊₁=(I−KₖHₖ)Pₖ
where:
Kₖ Kalman gain
H measurement matrix
P covariance matrix
R measurement noise matrix
zₖ current measurement
xₖ current state

The main updates will be compass—correct heading drift; accelerometers—correct pitch, roll; DVL—correct velocity drift; depth—correct z position; and USBL—correct x,y,z position.

The vehicle monitor monitors overall vehicle software and status to make sure that vehicle is operating correctly, takes action if any underwater vehicle 3 part is not working (i.e. navigation failure, would execute emergency surface). The input from sensors would be: Pitch, Roll, Yaw, Altitude, Velocity, Position when available from GPS. The output to motors would be: Fore: Rudder, Elevator, Thruster; and Aft: Rudder, Elevator, Thruster. The output to electrical distribution would be: turn of malfunctioning systems. The input to the electrical distribution would be: health of electrical systems (e.g. current draw, etc.). The failure modes and actions would be: main computer failure—stop mission and execute emergency surface, turn on emergency beacon; one thruster failure—continue mission, but adjust control algorithm to compensate for motor loss; and both thrusters fail—stop mission and execute emergency surface, turn on emergency beacon.

As noted above, the payload 208 receives commands from mission processor 206 to operate equipment such as sonar. The input from the mission processor for sonar would be: range, ping rate, TVG, resolution. If in pipeline following mode, the payload 208 should receive the location of pipeline so that trajectory can be plotted.

Although the above has been described with reference to certain specific embodiments, various modifications thereof will be apparent to those skilled in the art as outlined in the appended claims.

1. An underwater propulsion system comprising at least one assembly comprising a rudder configured to be rotatably connected to a hull of an underwater vehicle to permit rotation of said rudder with respect to said hull, an elevator pivotally attached to said rudder to pitch about an axis perpendicular to the axis of rotation of said rudder, and a thrust generator extending from and attached to said elevator such that said thrust generator pitches with said elevator.

2. The underwater propulsion system of claim 1 further comprising a pressurized housing located within said rudder.

3. The underwater propulsion system of claim 2 wherein said thrust generator comprises a propeller and a motor for driving said propeller.

4. The underwater propulsion system of claim 3 wherein said motor is controlled by a motor controller, said motor controller located in said pressurized housing.

5. The underwater propulsion system according to claim 3 wherein said motor is located within a housing and said propeller is positioned mid-way along said housing.

6. The underwater propulsion system according to claim 3 wherein said motor is located within a housing and said propeller is positioned towards the end of said housing.

7. The underwater propulsion system of claim 2 wherein said elevator is actuated by a motor, said motor located in said pressurized housing.

8. The underwater propulsion system of claim 7 wherein said motor is controlled by a motor controller, said motor controller located in said pressurized housing.

9. The underwater propulsion system according to claim 1 wherein said rudder is connectable to said hull of said underwater vehicle by a hollow shaft, said rudder able to rotate about said hollow shaft.

10. The underwater propulsion according to claim 1 wherein one or more sections of space defined within said rudder are free-flooding.

11. The underwater propulsion system of claim 10 wherein said rudder comprises one or more drainage holes fluidly connecting said one or more sections with said rudder's exterior, said one or more holes located along a surface of said rudder facing said hull.

12. The underwater propulsion according to claim 1 wherein one or more sections of space defined within said elevator are free-flooding.

13. The underwater propulsion system according to claim 1 wherein said rudder is rotatably connectable at both ends to different portions of said underwater vehicle.

14. The underwater propulsion system according to claim 1 wherein said elevator comprises a starboard plane positioned towards the right of said rudder and a portside plane positioned towards the left of said rudder, and each said starboard and portside planes able to move independently from one another.

15. The underwater propulsion system according to claim 1 wherein said underwater propulsion system is able to be oriented on to its side so that said rudder functions to control the pitch of said underwater vehicle and said elevator functions to control the yaw of said underwater vehicle.

16. An underwater vehicle comprising:
a first body and a second body positioned in spaced relation to one another and separated by at least one propulsion system; and
each of said at least one propulsion system comprising:
a vertically oriented rudder configured to be rotatably connected between said first and second bodies and is fully rotatable about an axis of rotation;
an elevator pivotally attached to said rudder to pitch about an axis perpendicular to the axis of rotation of said rudder; and
a thrust generator extending from and attached to said elevator such that said thrust generator pitches with said elevator.

17. The underwater vehicle according to claim 16 wherein said first body is positioned vertically above said second body.

18. The underwater vehicle according to claim 17 wherein said second body is more buoyant than said first body.

19. The underwater vehicle according to claim 16 wherein either said first body or said second body houses a vehicle control unit for controlling said at least one propulsion assembly.

20. The underwater vehicle according to claim 19 further comprising a hollow shaft extending between said first body and said second body, said rudder rotating about said shaft.

21. The underwater vehicle according to claim 20 further comprising cabling routed through said hollow shaft from any one of said upper body and said lower body.

22. The underwater vehicle according to claim 16 wherein two propulsion systems are connected to and separate the first body and the second body.

23. The underwater vehicle according to claim 22 wherein an aft propulsion system is positioned towards the aft of the underwater vehicle and a fore propulsion system is positioned towards the fore of the underwater vehicle.

24. The underwater vehicle according to claim 23 further comprising computer executable instructions for executing a zero-radius turn when said fore propulsion system's rudder faces either starboard or portside, and said aft propulsion system's rudder faces the other of either starboard or portside.

25. The underwater vehicle according to claim 23 further comprising computer executable instructions for executing a crabbing manoeuvre when said fore propulsion system's rudder faces either starboard or portside, and said aft propulsion system's rudder faces the same orientation.
